(19) United States
(12) Patent Application Publication
(10) Pub. No.: US 2011/0093827 A1
(43) Pub. Date: Apr. 21, 2011

(54) SEMICONDUCTOR DEVICE DESIGN METHOD

(75) Inventors: Koki TSURUSAKI, Kanagawa (JP); Satoshi Shibatani, Kanagawa (JP)

(73) Assignee: RENESAS ELECTRONICS CORPORAION

(21) Appl. No.: 12/906,117

(22) Filed: Oct. 17, 2010

(30) Foreign Application Priority Data
Oct. 16, 2009 (JP) 2009-239619

(51) Int. Cl. G06F 17/50

(52) U.S. Cl. 716/113; 716/126; 716/118

(57) ABSTRACT

There is provided a semiconductor device design method capable of achieving optimal layout design. For example, from the entire semiconductor device, a plurality of seeds which are flip-flops are set uniformly. In the first trace, the effective range (node) of each seed is expanded in parallel so that the respective objective function values (including difficulty levels of timing convergence) of the nodes are equalized. Then, in the first merge, adjacent seeds are merged as appropriate so that the number of nodes decreases to a certain rate, and a total cost containing the difficulty level of each node and the difficulty level of circuits remaining in the entire semiconductor device is calculated. Until the total cost worsens, as in the first trace and merge, the second trace and merge, the third trace and merge, . . . are performed. Based on optimal division units thereby determined, floorplan, division layout, and the like are performed.

### CROSS-REFERENCE TO RELATED APPLICATIONS

The disclosure of Japanese Patent Application No. 2009-239619 filed on Oct. 16, 2009 including the specification, drawings and abstract is incorporated herein by reference in its entirety.

### BACKGROUND OF THE INVENTION

The present invention relates to a semiconductor device design method, and in particular, relates to a technique effective when applied as a division method for dividing the overall layout and performing automatic layout.

For example, Japanese Unexamined Patent Publication No. Hei 6 (1994)-348784 (Patent Document 1) describes a method for, in detailed wiring performed in parallel on wiring areas formed by dividing a wiring area after rough wiring, equalizing the respective detailed-wiring times of the divided wiring areas. Specifically, there is performed processing for calculating respective coarse-grid wiring loads, and with a plurality of seeds as origins, whose number is set to the number of processors, sequentially selecting from among adjacent seeds and merging coarse grids of smaller increments in detailed wiring loads merged. Further, each coarse-grid wiring load is determined based on the number of wires, the amount of wiring prohibition, and the distortion rate of grid shape contained in the respective coarse grid.

### SUMMARY OF THE INVENTION

For example, a hierarchical layout method is known as a method for implementing a large-scale semiconductor chip. FIGS. 29A to 29C illustrate an example of a general hierarchical layout method, in which FIG. 29A is a flowchart showing the flow of processing, FIG. 29B is a logical hierarchy diagram of design data as input, and FIG. 29C is a schematic diagram of a layout as output. First, netlist data having a logical hierarchy structure as shown in FIG. 29B is provided as input. In the example of FIG. 29B, the highest hierarchy TOP which is the entire circuit is divided into three blocks BLK_A to BLK_C of a lower layer. Further, the block BLK_C is divided into two blocks BLK_D and BLK_E of a lower layer. Each block is a functional unit.

In layout design using such input data, generally first through tentative layout (floorplan), rough layout of each block and rough wiring between blocks are performed based on the logical structure of FIG. 29B (S2901). Then, through parallel processing with each block as a division unit, rough circuit layout and wiring between circuits within each block are determined (S2902, S2903). Then, layout adjustment and optimization are performed on the entire circuit as appropriate (S2904), and clock design is performed (S2905). Then, again through parallel processing with each block as a division unit, detailed circuit layout and wiring between circuits within each block are determined, and detailed wiring between blocks is also determined (S2906, S2907). As a result, a layout corresponding to the logical hierarchy structure of FIG. 29B is obtained as shown in FIG. 29C.

Thus, in the hierarchical layout method, data is divided generally based on the logical hierarchy, that is, the blocks divided with the functional units in the semiconductor chip, and with each divided data as a parallel processing unit, a computer system performs automatic layout. However, in this case, from the viewpoint of the entire semiconductor chip, there is a high possibility of unevenness in the logical size (the number of cells and the number of nets) of each block, leading to unevenness in the amount of each processing data, which may increase the overall layout processing time.

On the other hand, for example, assume that the circuit is divided into block units in the following way (A) or (B). (A) The circuit is divided into each block that has an equal number of gates (equal cell area) and equal block area. (B) The circuit is divided into each block that has an equal number of interface pins. Performing such division so that each block has an equal amount of processing data might be expected to equalize the respective layout processing times for the blocks and shorten the overall layout processing time. However, in this case as well, the blocks have different difficulty levels of timing convergence, which may increase the overall layout processing time. That is, based on timing constraints obtained by dividing (budgeting) the timing constraints (SDC) of the entire semiconductor chip into block units, the layout is determined so as to satisfy the constraints; however, for example, different operating frequencies of the blocks lead to different difficulty levels of timing constraints, which makes it difficult to estimate the overall layout processing time including the time required for optimization in the highest hierarchy.

FIG. 25A is a block diagram showing a configuration example of a typical microcomputer, FIG. 25B is a diagram showing an example of the logical hierarchy of the microcomputer in FIG. 25A, and FIG. 25C is a diagram showing an example of the logic scale of the microcomputer in FIG. 25A. The microcomputer shown in FIG. 25A includes an arithmetic processing block CPU, a DMA (Direct Memory Access) control block DMAC, a volatile memory block RAM, a nonvolatile memory block ROM, a timer block TMR, an analog-digital conversion block A/D, an external port control block I/O, and two buses BSh and BS1. BSh operates at 100 MHz, and BS1 operates at 50 MHz. CPU, TMR, and A/D are coupled to only BS1, whereas the other blocks are coupled to both BSh and BS1 so that they can operate at 100 MHz or 50 MHz in accordance with mode setting.

The microcomputer is classified for example as in FIG. 25B in terms of logic (function), and a netlist (circuit diagram data) and the like are managed based on this classification. In FIG. 25B, the highest hierarchy TOP is divided into CPU, I/O, a memory MEM, DMAC, and a peripheral module PERI of a lower layer; MEM is divided into RAM and ROM of a lower layer; and PERI is divided into TMR and A/D of a lower layer. TOP itself includes, for example, BSh and BS1. In the logic scale of each block, for example, CPU has the largest logic scale (200 kG), and RAM and ROM have the smallest logic scale (20 kG), as shown in FIG. 25C. The logic scale of RAM and ROM is the logic scale of a random gate unit (control circuit) excluding hard macro (i.e., memory core sections RAM_CR, ROM_CR).

FIG. 26A is a schematic diagram showing an example of the floorplan of the microcomputer in FIG. 25A, and FIG. 26B is a diagram showing an example of the processing time for each block in FIG. 26A on which automatic layout processing is performed. As shown in FIG. 26A, the area of each block in the microcomputer basically corresponds to the logic scale shown in FIG. 25C. Blocks indicated in italics operate at a maximum frequency of 100 MHz, and the others operate at 50 MHz. From the viewpoint of the logic scale, the layout processing time for CPU is expected to be the longest. However, in reality, as shown in FIG. 26B, the layout processing time for DMAC whose logic scale (80 kG) is less than half that of CPU is the longest (about double that of CPU). This is because, due to the higher operating frequency of DMAC, it takes time particularly to find a layout that does not cause a timing violation. Since TMR and A/D have the small logic scales and the low frequency, their layout processing times are less than one-quarter that of DMAC.

Such unevenness in layout processing time for each block increases the overall layout processing time and the design time. For example, there is a method for dividing the entire semiconductor chip into blocks whose number is equal to the number of CPUs and setting the division boundary so as to equalize the respective numbers of wires for the division blocks, as in Patent Document 1. However, this method does not necessarily bring about optimal division because the processing time varies depending on the operating frequency of the line as well as the number of wires as described above. Further, although this method is intended to equalize layout processing times in detailed wiring; from another point of view, that is, from the overall viewpoint of the layout design of the semiconductor device, it is not possible to sufficiently optimize layout design only by equalizing processing times in detailed wiring.

That is, in conventional layout methods such as Patent Document 1, after a predetermined rough layout is divided into, for example, blocks whose number is equal to the number of CPUs, detailed layout is performed, thereby shortening the overall layout processing time. However, in the first place, the rough layout itself is not necessarily optimal from the overall viewpoint of the design of the semiconductor device. Specifically, the method such as Patent Document 1 is intended to determine, on the condition that each block layout is determined as shown in FIG. 26A and each circuit layout in each block is determined to some extent, division boundary lines for equalizing processing times in the subsequent detailed wiring. However, unevenness in rough circuit layout in each block or each block layout itself as the precondition prevents optimization for the whole design even if only the layout processing times are equalized. For example, problems associated with the unevenness include partial supply voltage drops due to the concentration of high-power circuits and increases in simultaneous-switching noise due to the concentration of simultaneously operating circuits.

Further, in recent years, multilayer layout has sometimes been performed through the three-dimensional stack, as shown in FIG. 27A. FIG. 27A is a schematic diagram showing a configuration example of a multilayer chip, and FIG. 27B is a diagram showing an example of the logical hierarchy of the multilayer chip in FIG. 27A. In FIG. 27A, two semiconductor chips CP1 and CP2 are stacked and coupled through a plurality of vias (TSV: Through Silicon Via). A plurality of circuit blocks BLK_A and BLK_B are implemented on CP1, and a plurality of circuit blocks BLK_C and BLK_D are implemented on CP2. These circuit blocks integrally configure one semiconductor device.

In the case of performing such multilayer layout, usually, with each circuit block BLK_A to BLK_D as a functional unit, the circuit blocks are allocated to the semiconductor chips as appropriate in such a way that similar functions are contained in one semiconductor chip. FIGS. 28A and 28B show examples of indexes obtained from the layout result of the multilayer chip in FIG. 27A, in which FIG. 28A is an explanatory diagram showing the layout processing time for each chip, and FIG. 28B is an explanatory diagram showing the power consumption of each chip. In FIG. 28A, BLK_A and BLK_B are larger in logic scale or higher in layout complexity than BLK_C and BLK_D, which makes a big difference in layout processing time between CP1 and CP2. Further, in FIG. 28B, BLK_D is much larger in power consumption than the other circuit blocks, which makes a big difference in power consumption between CP1 and CP2.

From the overall viewpoint of the design of the semiconductor device, it is desirable to equalize the respective layout processing times for the semiconductor chips and equalize power consumption, noise, and the like. Particularly in the case of the multilayer layout, unevenness-associated trouble in an advanced stage of design causes a large loss with redesign; therefore, it is necessary to implement uniform layout design in an early stage. This unevenness problem applies, as a matter of course, not only to the multilayer layout but also to the layout of a single semiconductor chip, so that it is desirable to equalize the respective layout processing times for the circuit blocks in the single semiconductor chip and equalize power consumption, noise, and the like. However, in reality, a trade-off relationship exists, and a scheme for obtaining an optimal solution is required.

The present invention has been made in view of such a circumstance, and it is an object of the invention to provide a semiconductor device design method capable of achieving optimal layout design. The above and other objects and novel features of the present invention will become apparent from the description of this specification and the accompanying drawings.

A typical embodiment of the invention disclosed in the present application will be briefly described as follows.

In a semiconductor device design method according to this embodiment, an objective function which is a function of the length of layout processing time in consideration of timing convergence, the magnitude of power, the level of noise, etc. and represents the comprehensive complexity of layout is defined, and a computer system allocates the entire circuit of the highest hierarchy to N blocks so as to equalize the respective objective function values of the blocks, with a predetermined reference value as a target.

With this, it is possible to obtain a plurality of division blocks equalized comprehensively including layout processing time and quality. Therefore, by laying out each division block in parallel processing based on this result, it is possible to shorten the layout processing time. Further, by performing floorplan or allocation to a plurality of semiconductor chips based on this result, it is possible to perform optimization including the quality of the semiconductor device and the layout processing time. Thus, it is possible to optimize the layout design from the comprehensive viewpoint.

Further, in the semiconductor device design method according to this embodiment, a total cost is calculated by reflecting, in the reference value, the complexity (e.g., the number of timing paths) of circuits remaining in the highest hierarchy which are circuits other than the N blocks, so that while the reference value is increased and the N value is decreased in stages, the total cost for each N value is calculated, thereby obtaining the N value of the best total cost and the corresponding boundary of each block. That is, it is also possible to search for an optimal solution to the number of division blocks.

More specifically, in the semiconductor device design method, a netlist of the entire circuit, timing information, and floorplan information FP in some cases are inputted. First, from the entire circuit, a plurality of seeds which are flip-flop circuits are set. Then, in the first trace, the effective range of each seed is expanded in stages so that the respective objective function values are equalized among the effective ranges of the seeds. The expansion is performed by sequentially taking in preceding or subsequent flip-flops coupled to each seed. Then, a seed that meets a first condition in the process of expansion is converted into a subgraph, and the trace is continued until the number of remaining seeds which have not yet become a subgraph decreases to a first rate. Subsequently, in the first merge, subgraphs are merged as appropriate until the sum of the number of remaining seeds and the number of subgraphs decreases to a second rate. Then, a total cost in the case where division is performed with each of the remaining seeds and the subgraphs as a division unit is calculated in consideration of the number of timing paths etc. of circuits that do not belong to the remaining seeds or the subgraphs. As long as the total cost is better than the previous one, as in the first trace and merge, the second trace and merge, the third trace and merge, . . . are performed.

Thus, a plurality of seeds are set beforehand, the effective range of each seed is expanded in stages, and subgraphed seeds are merged as appropriate, thereby decreasing the overall division number in stages and checking whether the total cost is improved, so that an optimal division number can be obtained efficiently. The seed that meets the first condition in the above description refers to a seed that reaches the following state. All perimeters of the effective range of the seed come into contact with the effective ranges of other seeds and cannot expand any further. Alternatively, in the case where the netlist is managed with a hierarchy block, all perimeters of the effective range of the seed reach the boundary of a hierarchy block to which the seed belongs.

According to an effect of the typical embodiment of the invention disclosed in the present application, it is possible to optimize the layout design.

### BRIEF DESCRIPTION OF THE DRAWINGS

FIG. 1 is a flowchart showing an example of processing in a semiconductor device design method according to a first embodiment of the present invention.

FIG. 2 is a schematic diagram showing an example of transition of processing objects, in accordance with the flow of FIG. 1.

FIGS. 3A to 3C are conceptual diagrams showing an example of the advantages of the design method in FIG. 1.

FIG. 4 is a diagram illustrating an example of a seed selection method in the design method of FIG. 1.

FIG. 5 is a diagram illustrating an example of the seed selection method in the design method of FIG. 1.

FIGS. 6A to 6C are diagrams illustrating layout processing cost contained in an objective function used in a trace in the design method of FIG. 1.

FIG. 7 is a diagram illustrating layout processing cost contained in the objective function used in the trace in the design method of FIG. 1.

FIG. 8 is a diagram illustrating layout processing cost contained in the objective function used in the trace in the design method of FIG. 1.

FIG. 9 is a diagram illustrating layout processing cost contained in the objective function used in the trace in the design method of FIG. 1.

FIG. 10 is a diagram illustrating layout processing cost contained in the objective function used in the trace in the design method of FIG. 1.

FIG. 11 is an explanatory diagram showing an example of a method for calculating the objective function in the case where a semiconductor device to be designed has a plurality of modes in the design method of FIG. 1.

FIG. 12 is an explanatory diagram showing an overview of a node expansion method in the trace in the design method of FIG. 1.

FIG. 13 is another explanatory diagram showing an overview of the node expansion method in the trace in the design method of FIG. 1.

FIGS. 14A and 14B are conceptual diagrams showing an example of a processing method in the case where nodes come into contact with each other in the process of node expansion in FIGS. 12 and 13, in which FIG. 14A shows the case of a flat hierarchy, and FIG. 14B shows the case of maintaining a logical hierarchy.

FIG. 15 is an explanatory diagram showing an example of how to determine a boundary in the case where nodes come into contact with each other in the process of node expansion in FIGS. 12 and 13.

FIG. 16 is a conceptual diagram showing an example of changes in objective functions in the process of the trace in the design method of FIG. 1.

FIG. 17 is a conceptual diagram showing an example of a trace graph generated in the trace in the design method of FIG. 1.

FIG. 18 is a conceptual diagram showing an example of a merge graph generated in a merge in the design method of FIG. 1.

FIG. 19 is an explanatory diagram of total cost calculation in the design method of FIG. 1.

FIG. 20 is a flowchart showing an example of processing in a semiconductor device design method according to a third embodiment of the invention.

FIG. 21 is a schematic diagram showing an example of transition of processing objects, in accordance with the flow of FIG. 20.

FIG. 22 is an explanatory diagram showing an example of a merge graph and a trace graph, in accordance with the transition of FIG. 21.

FIG. 23 is a schematic diagram showing another example of transition of processing objects, in accordance with the flow of FIG. 20

FIG. 24 is a schematic diagram following FIG. 23.

FIG. 25A is a block diagram showing a configuration example of a typical microcomputer, FIG. 25B is a diagram showing an example of the logical hierarchy of the microcomputer in FIG. 25A, and FIG. 25C is a diagram showing an example of the logic scale of the microcomputer in FIG. 25A.

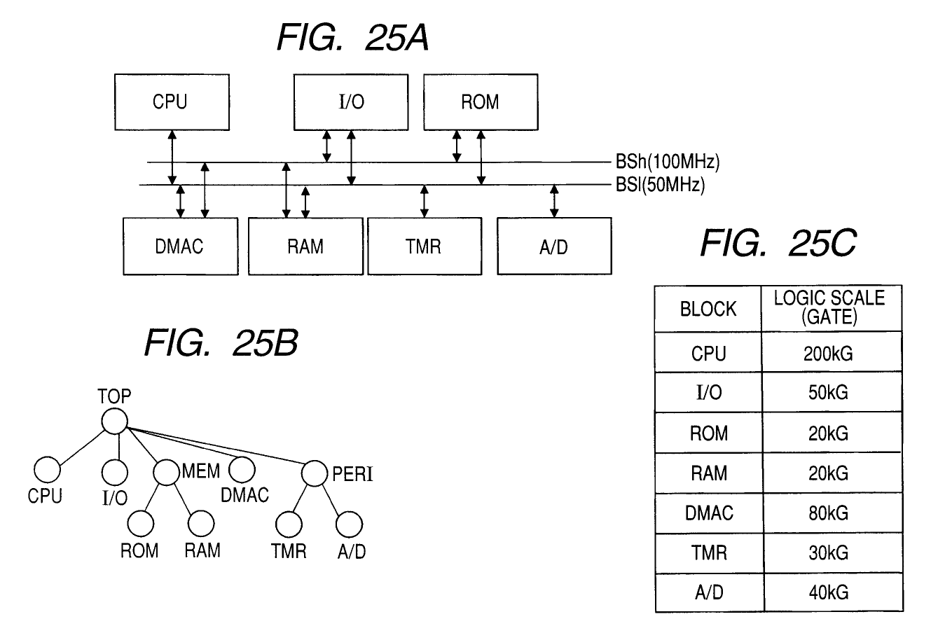

FIG. 26A is a schematic diagram showing an example of the floorplan of the microcomputer in FIG. 25A, and FIG. 26B is a diagram showing an example of the processing time for each block in FIG. 26A on which automatic layout processing is performed.

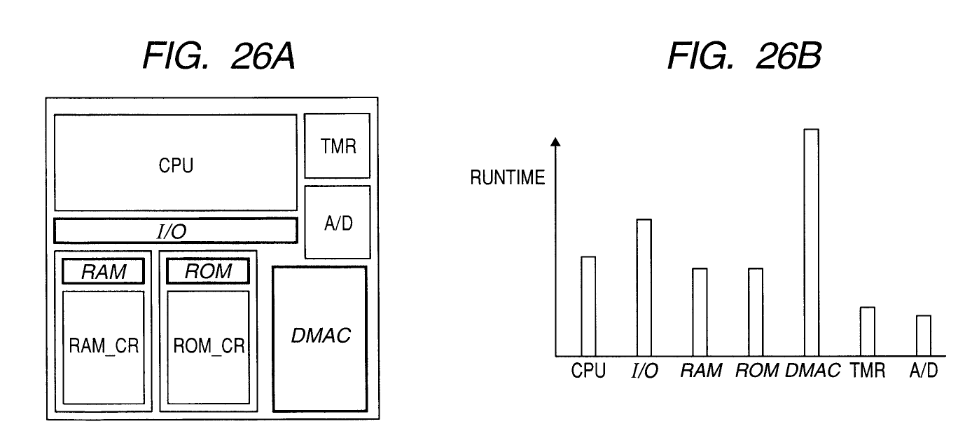

FIG. 27A is a schematic diagram showing a configuration example of a multilayer chip, and FIG. 27B is a diagram showing an example of the logical hierarchy of the multilayer chip in FIG. 27A.

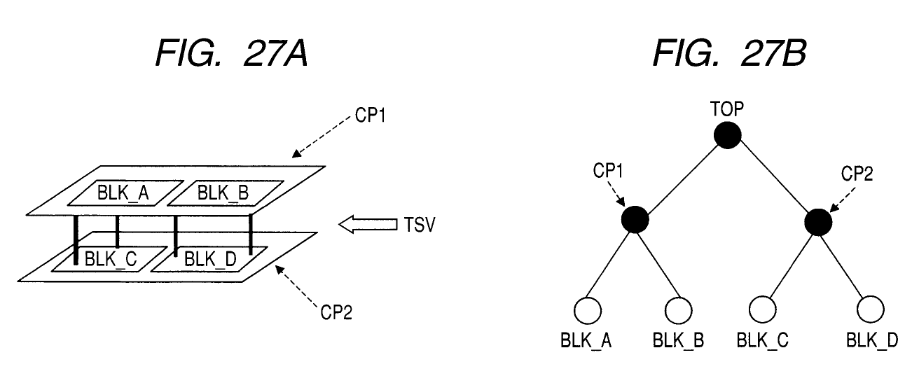

FIGS. 28A and 28B show examples of indexes obtained from the layout result of the multilayer chip in FIG. 27A, in which FIG. 28A is an explanatory diagram showing the layout processing time for each chip, and FIG. 28B is an explanatory diagram showing the power consumption of each chip.

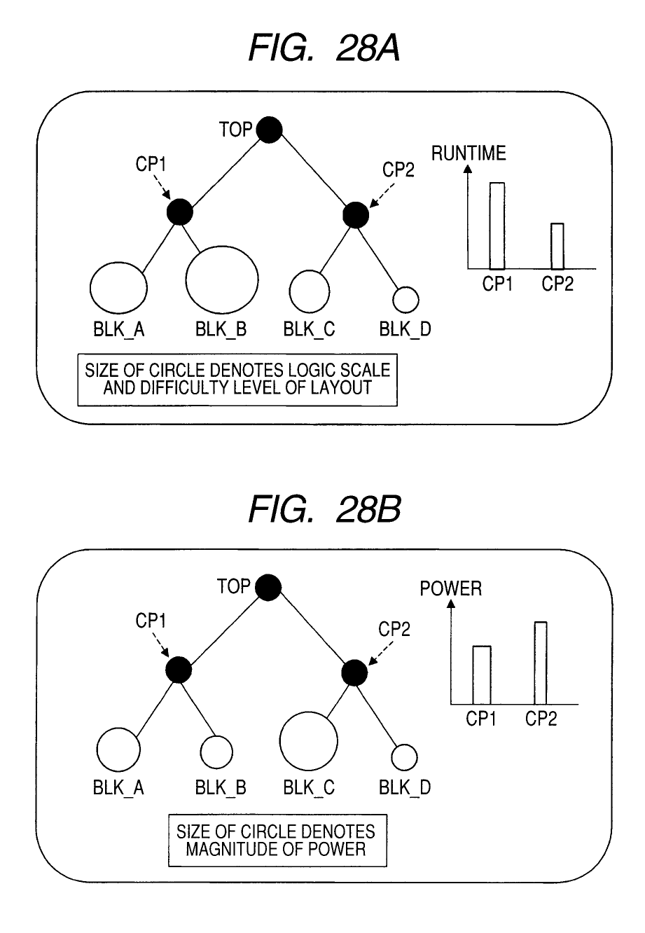

FIGS. 29A to 29C illustrate an example of a general hierarchical layout method, in which FIG. 29A is a flowchart showing the flow of processing, FIG. 29B is a logical hierarchy diagram of design data as input, and FIG. 29C is a schematic diagram of a layout as output.

### DESCRIPTION OF THE PREFERRED EMBODIMENTS

In the following embodiments, description will be made by dividing an embodiment into a plurality of sections or embodiments when necessary for the sake of convenience; however, except when a specific indication is given, they are not mutually unrelated, but there is a relationship that one section or embodiment is a modification, specification, or supplementary explanation of part or all of another section or embodiment. Further, in the case where the following embodiments deal with a numerical expression (including a number, a numerical value, amount, range) concerning elements, the numerical expression is not limited to the specific number but may be larger or smaller than the specific number except when a specific indication is given or when the expression is apparently limited to the specific number in principle.

Furthermore, in the following embodiments, the components (including element steps) are not always indispensable except when a specific indication is given or when they are apparently considered to be indispensable in principle. Similarly, in the case where the following embodiments deal with the shape, positional relationship, etc., of the components etc., those substantially approximate or similar to them in shape etc. are also included except when a specific indication is given or when they are apparently considered to be excluded in principle. This also applies to numerical values and ranges described above.

Hereinafter, preferred embodiments of the present invention will be described in detail with reference to the accompanying drawings. In all the drawings for illustrating the embodiments, the same components or members are basically denoted by the same reference numerals, and their description will not be repeated.

### First Embodiment

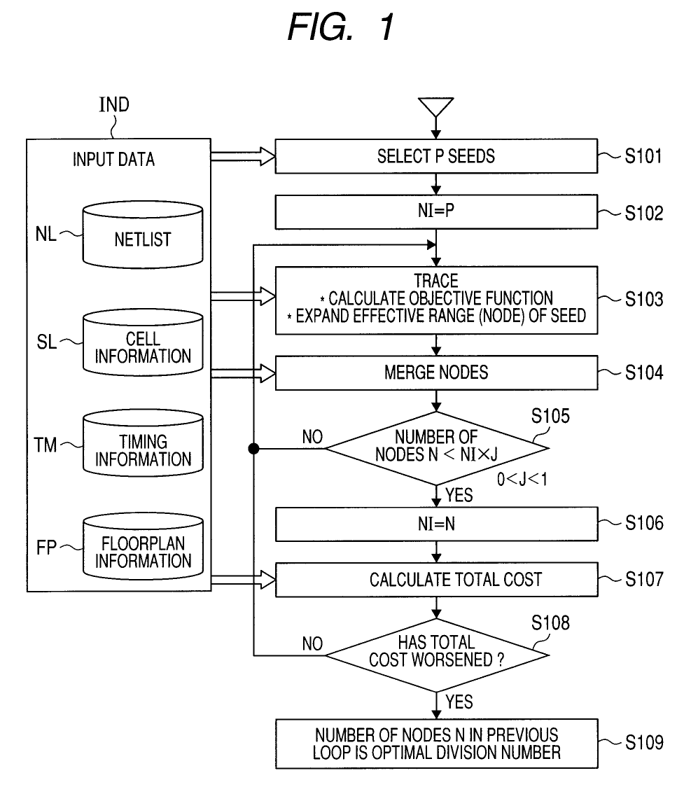

FIG. 1 is a flowchart showing an example of processing in a semiconductor device design method according to the first embodiment of the invention. The semiconductor device design method shown in FIG. 1 is implemented when a computer system executes programs in response to input data IND stored in a storage unit such as a hard disk. The input data IND contains a netlist NL, cell information SL about each cell contained in the netlist, timing information TM, and floorplan information FP in some cases.

In FIG. 1, first, the computer system refers to the netlist NL and selects P seeds therefrom (S101). Each seed is a flip-flop. After setting a reference value NI=P (S102), the computer system performs a trace (S103). In the trace, the computer system refers to the netlist NL and takes in preceding or subsequent flip-flops coupled to each seed as an origin, thereby expanding the effective range (referred to as “node”) of each seed in stages and in parallel. At this time, the computer system expands nodes so as to equalize the respective objective function values of the nodes while sequentially calculating each objective function based on the netlist NL, the cell information SL, and the timing information TM. Although the details will be described later, the objective function is a function of the length of layout processing time, the magnitude of power, the level of noise, etc. and represents the comprehensive complexity of layout. Then, if nodes come into contact with each other in the process of the trace, the computer system determines whether or not to merge these nodes. For example, if it is determined from the netlist NL and the floorplan information FP in some cases that there is a close relationship between the nodes and the value of the objective function after the merge can maintain a certain degree of uniformity with those of the other nodes, the computer system merges the nodes (S104).

Then, the computer system determines whether the number of nodes N after the merge is smaller than NI×J (S105). J is a constant (0<J<1) set beforehand by a user. If the condition of S105 is not satisfied, the computer system again performs a trace in S103. If the condition of S105 is satisfied, after setting the reference value NI=N (S106), the computer system calculates a total cost (S107). While the total cost value is improving, the computer system returns to S103 and repeats loop processing. If the total cost value has worsened, the computer system exits the loop and determines that the number of nodes N in the previous loop is an optimal division number (S108, S109).

The total cost is determined by adding the cost (the number of timing paths etc.) of circuits (i.e., circuits remaining in the highest hierarchy (TOP)) which do not belong to the nodes to the representative value (e.g., maximum value or average value) of the respective objective functions for the nodes, with each node laid out in parallel processing. Specifically, it is calculated, for example, by equation (1). In equation (1), α is an overhead coefficient depending on the number of nodes N and increases as the number of nodes N increases.

Total cost=max(respective objective function values of nodes)×α+top cost (1)

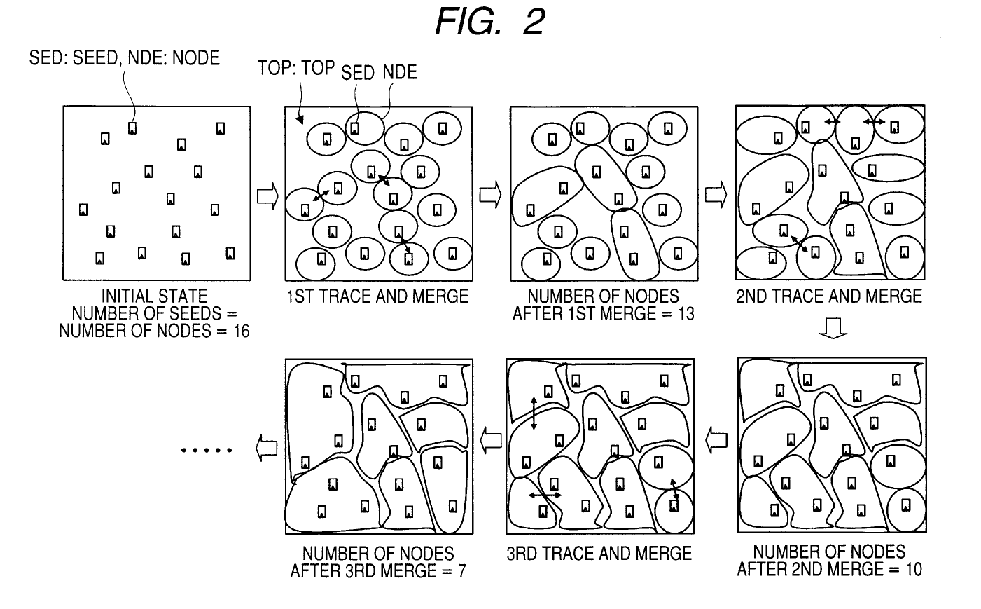

FIG. 2 is a schematic diagram showing an example of transition of processing objects, in accordance with the flow of FIG. 1. As shown in FIG. 2, first, P (16 in FIG. 2) seeds SED are selected uniformly from the entire circuit, as an initial state, and the first loop processing (trace and merge) corresponding to S103 to 5108 in FIG. 1 is performed. By the first merge, the number of nodes NDE decreases from 16 in the initial state to 13. Similarly, by the second loop processing, the number of nodes NDE decreases to 10, and by the third loop processing, the number of nodes NDE decreases to 7. In each loop processing, the total cost after the merge is calculated. For example, if the total cost has worsened by the third loop processing, the fourth and subsequent loop processing is not performed, the number of nodes (10) in the second loop processing is an optimal division number, and the boundary of each node NDE is an optimal division-block boundary.

Thus, the semiconductor device design method according to the first embodiment equalizes the comprehensive complexity of layout and searches for a division condition (division number and the boundary of each division block) for shortening the overall layout processing time. In the method, by performing traces, the complexity of each division block is increased in stages while the uniformity thereof is maintained. Concurrently, by performing merges, the division number is decreased in stages. Further, by calculating the total cost at each stage, the overall layout processing time is verified.

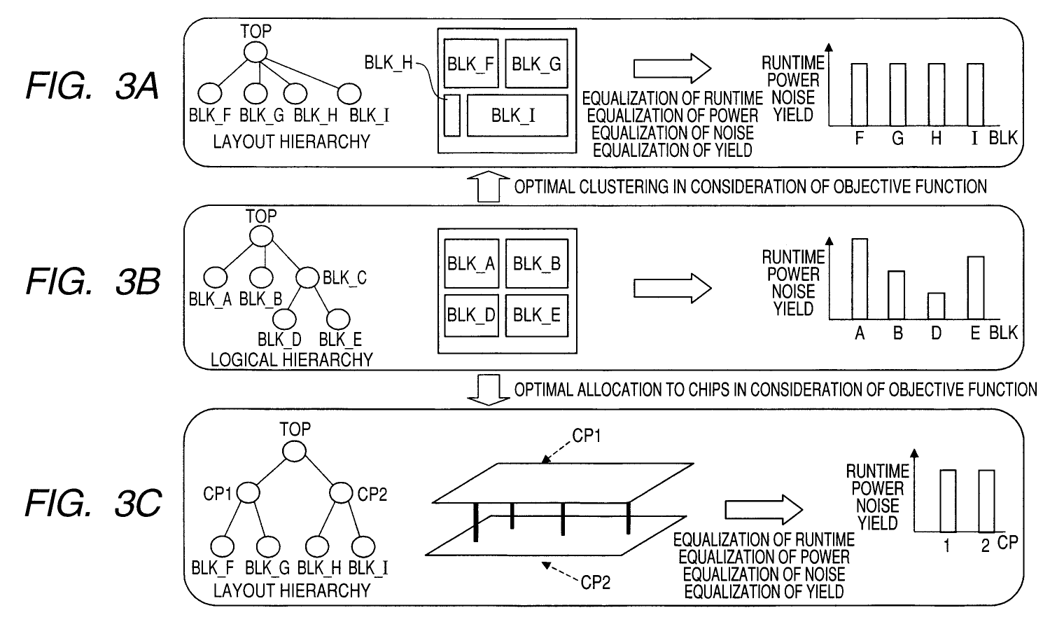

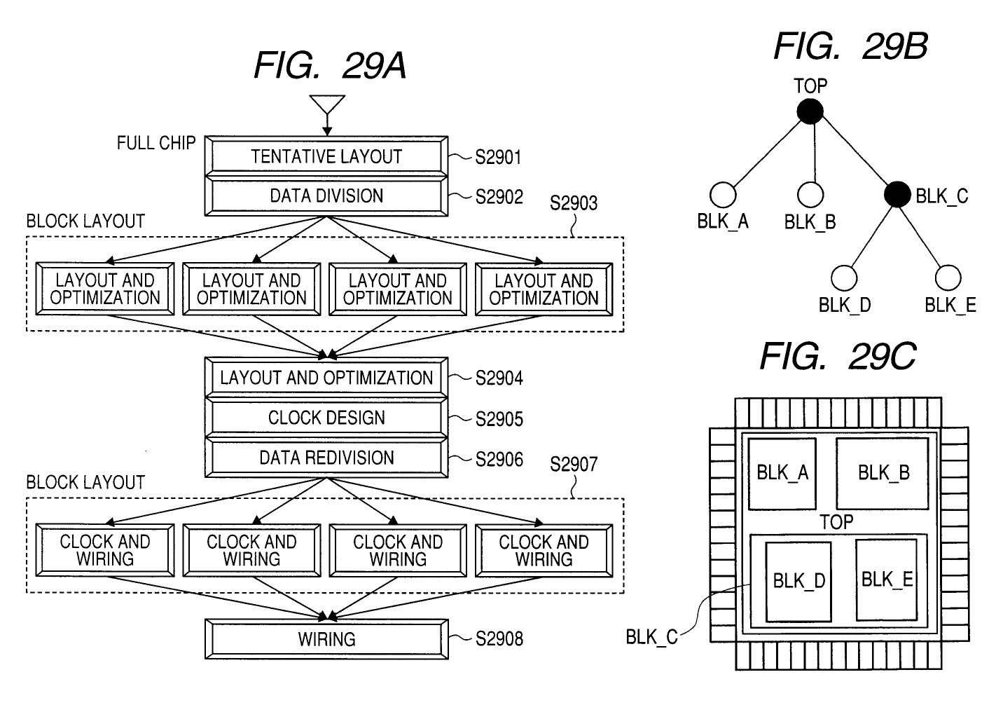

FIGS. 3A to 3C are conceptual diagrams showing an example of the advantages of the design method in FIG. 1. First, as shown in FIG. 3B, in the case of performing layout design with the blocks BLK_A to BLK_E as units based on the logical hierarchy, respective comprehensive indexes, for evaluating the blocks, grounded on layout processing time, power, noise level, and yield may vary greatly. On the other hand, with the design method in FIG. 1, a division condition for equalizing the comprehensive indexes can be obtained. Therefore, as shown in FIG. 3A, by performing layout design with the blocks BLK_F to BLK_I as units based on this division condition, the overall layout processing time can be shortened, and also the power, noise, and yield are equalized, which can enhance the quality of the semiconductor device. Specifically, with the blocks as units, tentative layout (floorplan) (S2901) and data division (S2902, S2906) in FIG. 29A are performed.

Further, as shown in FIG. 3C, by allocating the blocks BLK_F to BLK_I as units based on FIG. 1 to the chips CP1 and CP2, the layout processing time for the entire multilayer chip can be shortened, and also the power, noise, and yield are equalized, which can enhance the quality of the multilayer chip. In such allocation to the chips, various division numbers may be obtained as optimal solutions according to the design method in FIG. 1. However, since the division blocks have the equalized comprehensive indexes, the blocks can be allocated to the semiconductor chips as appropriate in consideration of the chip sizes etc.

Hereinafter, the flow of FIG. 1 will be detailed.

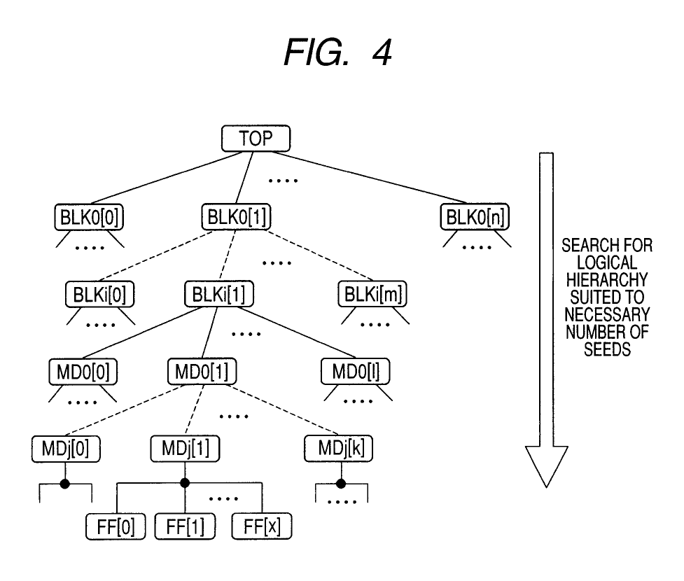

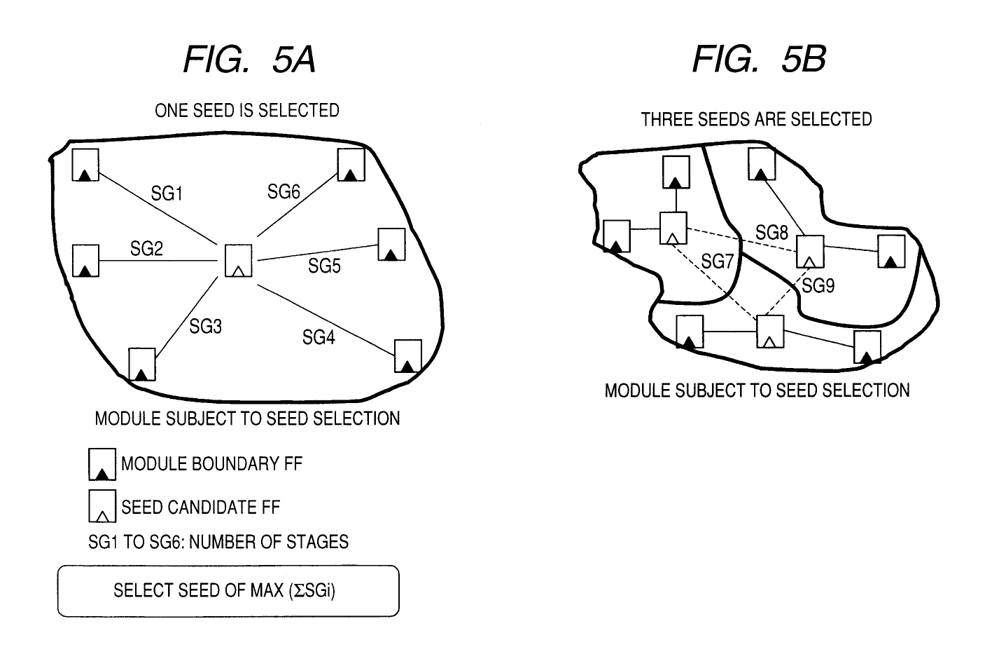

FIGS. 4 and 5 are diagrams illustrating an example of a seed selection method (S101) in the design method of FIG. 1. First, a certain number of seeds (flip-flops) are selected. Although not particularly limited, the number of flip-flops to be selected is, for example, about 1/50 of the number of flip-flops contained in the entire circuit (e.g., 7K if the number of all flip-flops is 350K). Further, it is desirable that each seed be selected uniformly from the entire circuit. For this reason, as shown in FIG. 4, the computer system searches the logical hierarchy of the netlist downwardly, and determines a hierarchy suited to the necessary number of seeds.

That is, generally in the logical hierarchy of the netlist, the highest hierarchy TOP includes a lower hierarchy comprised of a plurality of blocks BLK0[0] to BLK0[n] which are large functional units, and each lower hierarchy includes a further lower hierarchy comprised of a plurality of blocks which are relatively large functional units, thus forming the structure of predetermined successive hierarchies. For example, in a lower layer of BLK0[1], blocks BLKi[0] to BLKi[m] exist. Further, each block (e.g., BLKi[1]) located in the lower layer includes a lower hierarchy comprised of a plurality of modules (e.g., MD0[0] to MD0[1]) which are small functional units, and each lower hierarchy includes a lower hierarchy comprised of a plurality of modules, thus forming the structure of predetermined successive hierarchies. For example, in a lower layer of MD0[1], modules MDj[0] to MDj[k] exist. Further, a module (e.g., MDj[1]) in the lowest layer includes a plurality of flip-flops (e.g., FF[0] to FF[x]).

Accordingly, for example, if the number of modules located in a same hierarchy is nearly equal to the number of seeds, the computer system selects one seed from each module. For excess or deficiency, the computer system, for example, does not select a seed from some modules or selects several seeds from one module of particularly large circuit size. This makes it to select seeds uniformly from the entire circuit.

Further, in the selection of a seed from each module, it is desirable to select a seed of a flip-flop estimated to be located in the center of each module to the extent possible. For this reason, as shown in FIG. 5A, the computer system detects the boundary (i.e., flip-flops for input-output with the outside) of a module subject to seed selection by referring to the netlist NL, and selects a flip-flop farthest from the boundary as a seed. Specifically, the computer system searches for a flip-flop having the largest number of stages from each flip-flop located at the boundary (flip-flop stage number) (the sum of SG1 to SG6 in FIG. 5A), and sets it as the seed. Further, in the case of selecting several seeds from one module, as shown in FIG. 5B, the computer system selects each seed in such a way that the number of stages among the seeds (SG7 to SG9 in FIG. 5B) also becomes large.

After thus selecting seeds, the computer system performs a trace with each seed as an origin. In the trace, based on the objective function defined beforehand, the computer system expands nodes in parallel so as to equalize the respective objective function values of the nodes which are the effective ranges of the seeds. As described above, the objective function G is a function of cost (RT) representing the length of layout processing time (in other words, the difficulty level of layout convergence), cost (PW) representing the magnitude of power, cost (NS) representing the level of noise, and cost (YE) representing manufacturability (yield) as variables, and is expressed, for example, by equation (2). In equation (2), β1 to β4 are weighting coefficients for the variables, and can be arbitrarily set by the user.

G=β1×RT+β2×PW+β3×NS+β4×YE (2)

Hereinafter, the objective function G will be detailed.

[A] Power Cost (PW) and Manufacturability Cost (YE)

The power cost (PW) is an index representing a possibility of a drop in supply voltage due to partial power concentration. Assume that problems occur with increase in this value. The value of PW is determined, for example, by the sum of power consumption (acquired from the cell information SL) of each cell contained in a node of interest and recognized from the netlist NL. If cell activation rate information exists, the information is also added. Further, the fan-out of each cell is recognized from the netlist NL, and wiring capacity associated with the fan-out is added as weight. Next, the value of the manufacturability cost (YE) is determined, for example, by the sum of yield (acquired from the cell information SL) of each cell contained in a node of interest and recognized from the netlist NL. Assume that problems occur with increase in this value.

[B] Layout Processing Time Cost (RT)

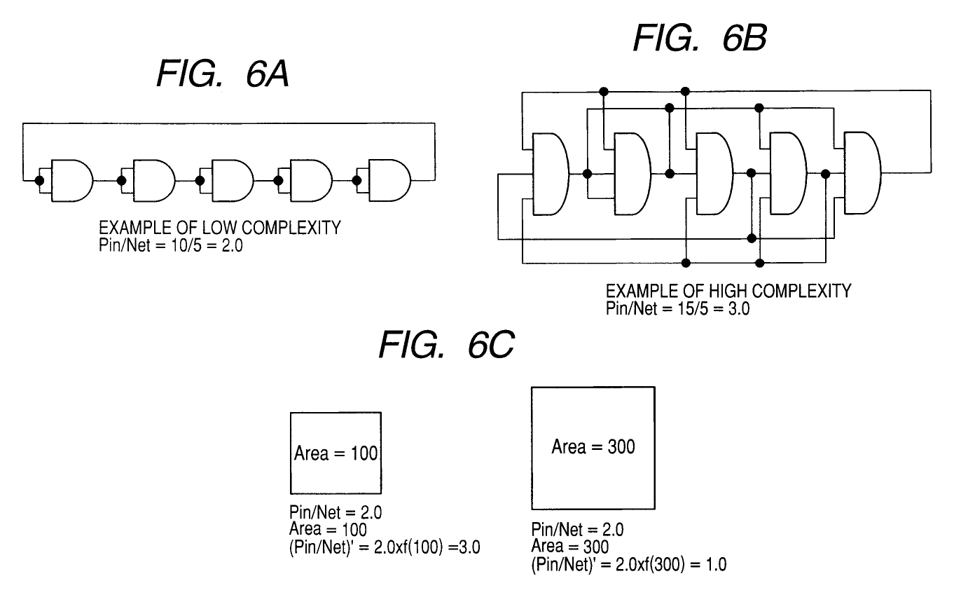

The layout processing time cost (RT) is determined, for example, by a function of four variables comprised of [1] Pin/Net, [2] the sum of the speeds of clocks supplied to flip-flops (CKSUM), [3] the number of endpoints (EP), and [4] the sum of timing slacks (TPS). FIGS. 6 to 10 are diagrams illustrating layout processing cost contained in the objective function used in the trace (S103) in the design method of FIG. 1.

First, [1] Pin/Net is obtained by detecting the number of pins and the number of nets (the number of wires) contained in a node of interest by referring to the netlist NL. In general, as this value increases, the complexity (difficulty level) of layout increases, and the layout processing time increases. For example, FIG. 6A shows a circuit example in which Pin/Net=2.0, and FIG. 6B shows a circuit example in which Pin/Net=3.0. Further, the complexity also depends on the area of the node, that is, the complexity decreases as the area increases. Accordingly, if the design method according to this embodiment is used in layout design after floorplan, (Pin/Net)' is calculated by correcting Pin/Net by reflecting an approximate area found with the floorplan information FP. In the example of FIG. 6C, Pin/Net is multiplied by a function f inversely proportional to an area. Although both Pin/Net are 2.0, (Pin/Net)′=3.0 in the case of an area of 100, and (Pin/Net)′=1.0 in the case of an area of 300.

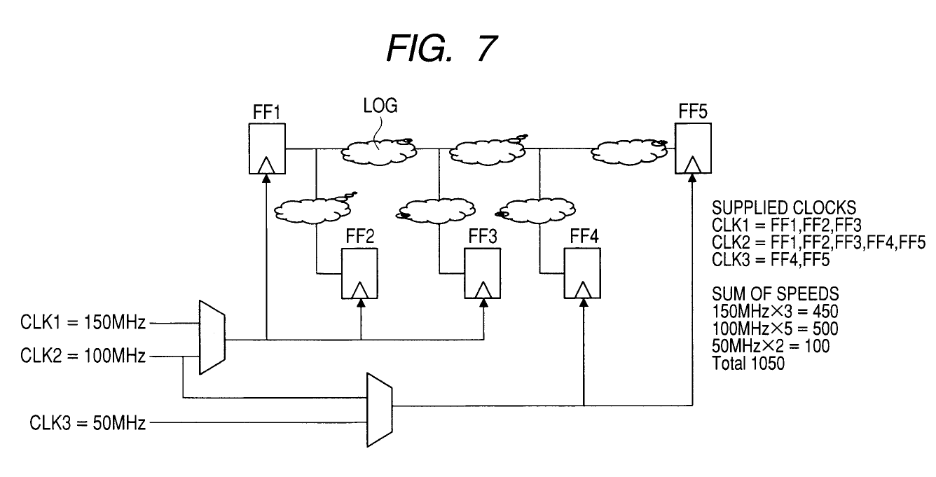

Next, [2] the sum of the speeds of clocks supplied to flip-flops (CKSUM) is obtained by recognizing clock information of flip-flops contained in a node of interest by referring to the netlist NL and the timing information TM. As the sum of the clock speeds increases, the difficulty level of timing convergence increases, and the layout processing time increases. FIG. 7 shows five flip-flops FF1 to FF5 coupled as appropriate through combinational circuits LOG. The clock CLK1 of 150 MHz and the clock CLK2 of 100 MHz are selectively supplied to FF1 to FF3, and the clock CLK2 and the clock CLK3 of 50 MHz are selectively supplied to FF4 and FF5. In such a circuit, since CLK1 (150 MHz) is supplied to three FFs, CLK2 (100 MHz) is supplied to five FFs, and CLK3 (50 MHz) is supplied to two FFs, the sum of the clock speeds (CKSUM)=150×3+100×5+50×2=1050.

To be more precise, the difficulty level associated with the sum of the clock speeds (CKSUM) changes depending on the number of logic stages of each combinational circuit LOG in the example of FIG. 7. Accordingly, it is desirable to detect the number of logic stages from the netlist NL and reflect it in CKSUM. In this case, in timing paths for each frequency supplied to FFs, a function of the maximum number of logic stages of each timing path is used. That is, assume that the numbers of logic stages for each clock supplied to FF1 to FF5 in FIG. 7 are represented by values in parentheses as indicated below. For example, CLK1=FF1(10) denotes that in the case where FF1 operates with CLK1, a signal is inputted through a combinational circuit LOG comprised of ten logic stages.

CLK1=FF1(10), FF2(15), FF3(15) CLK2=FF1(25), FF2(30), FF3(30), FF4(40), FF5(40) CLK3=FF4(40), FF5(40)
The above numbers of logic stages are reflected in CKSUM. With a function f in which the value thereof becomes 1 when the number of logic stages is a reference number, the value increases from 1 as the number of logic stages increases from the reference number, and the value decreases from 1 as the number of logic stages decreases from the reference number, the sum of the clock speeds (CKSUM)′ is calculated as follows.

150 MHz×(f(10)+f(15)+f(15)=3.4)=510

100 MHz×(f(25)+f(30)+f(30)+f(40)+f(40)=5.3)=515

50 MHz×(f(40)+f(40)=0.8)=40

(CKSUM)′=510+515+40=1065

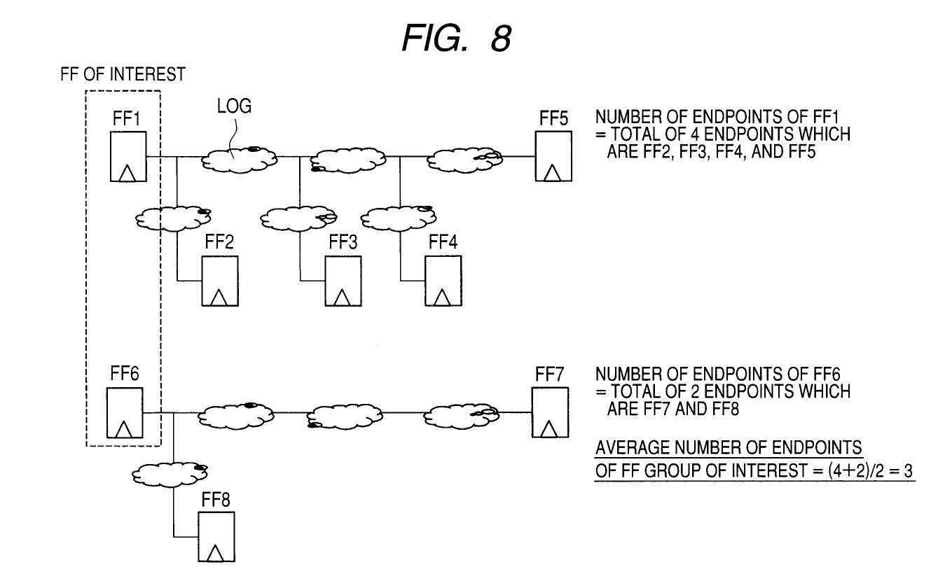

Next, [3] the number of endpoints (EP) is obtained by recognizing the number of endpoints for each flip-flop contained in a node of interest by referring to the netlist NL. As the number of endpoints (EP) increases, the difficulty level of layout increases, and the layout processing time increases. FIG. 8 shows five flip-flops FF1 to FF5 coupled as appropriate through combinational circuits LOG and three flip-flops FF6 to FF8 coupled as appropriate through combinational circuits LOG. FF1 has four endpoints which are FF2 to FF5, and FF6 has two endpoints which are FF7 and FF8. Accordingly, in the case of focusing on e.g. FF1 and FF6, the number of endpoints (EP) is obtained, for example, by calculating the average which is 3.

Next, [4] the sum of timing slacks (TPS) is obtained by recognizing each timing path contained in a node of interest and the result of STA (static timing analysis) of each timing path by referring to the netlist NL and the timing information TM. The result of STA is obtained beforehand in a circuit design stage and stored as the timing information TM. The sum of timing slacks (TPS) increases, the difficulty level of timing convergence increases, and the layout processing time increases.

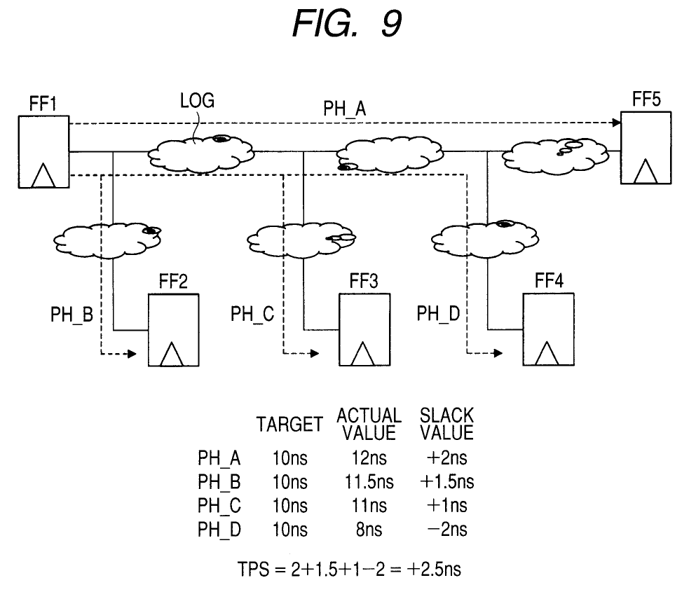

FIG. 9 shows five flip-flops FF1 to FF5. A timing path PH_A through combinational circuits LOG exists between FF1 and FF5. Similarly, timing paths PH_B, PH_C, and PH_D exist between FF1 and FF2, FF1 and FF3, and FF1 and FF4, respectively. Here, assume that the transmission times of PH_A, PH_B, PH_C, and PH_D are, for example, 12 ns, 11.5 ns, llns, and 8 ns by STA (static timing analysis). In the case where the target of each timing path is a 10 ns period (100 MHz), the timing slack values of PH_A, PH_B, PH_C, and PH_D are +2 ns, +1.5 ns, +1.0 ns, and −2 ns, respectively. Therefore, the sum of timing slacks (TPS)=2+1.5+1−2=+2.5 ns.

Thus, the layout processing time cost (RT) is calculated by the function of four variables comprised of [1] Pin/Net, [2] the sum of clock speeds (CKSUM), [3] the number of endpoints (EP), and [4] the sum of timing slacks (TPS). Specifically, for example, as expressed by equation (3), the variables are weighted by γ1 to γ4 to calculate RT.

RT=γ1×(Pin/Net)+γ2×CKSUM+γ3×EP+γ4×TPS (3)

[C] Noise Cost (NS)

The noise cost (NS) is an index representing a possibility of degradation of chip performance due to occurrence of partial simultaneous-switching noise. Assume that problems occur with increase in this value. The value of NS is calculated, for example, by detecting the number of flip-flops triggered by the same clock by referring to the netlist NL. In particular, it is calculated by detecting the number of flip-flops that are the fan-out of the same clock gating cell.

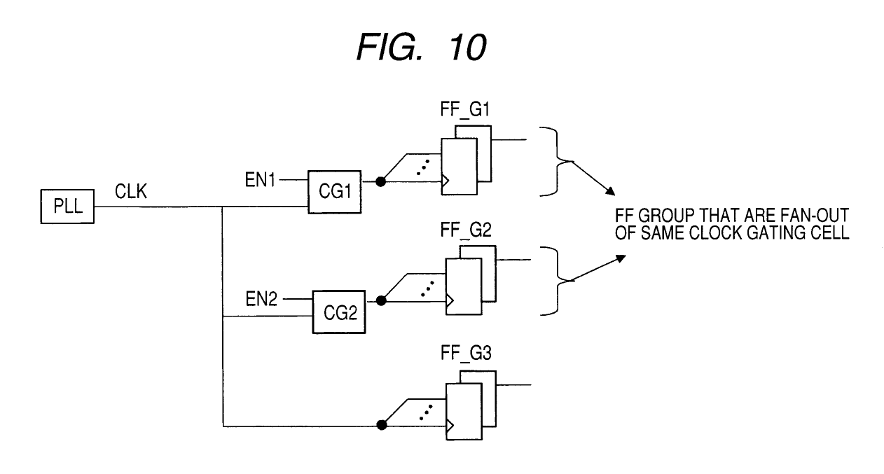

FIG. 10 shows a flip-flop group FF_G3 to which a clock CLK is supplied directly from a clock generation circuit PLL, a flip-flop group FF_G1 to which the clock is supplied through a clock gating cell CG1, and a flip-flop group FF_G2 to which the clock is supplied through a clock gating cell CG2. CG1 controls the supply and cutoff of CLK in response to an enable signal EN1, and CG2 controls the supply and cutoff of CLK in response to an enable signal EN2. In FF_G1 which is the fan-out of CG1 and FF_G2 which is the fan-out of CG2, generally, flip-flops in each group are closely arranged, which leads to small skew and large simultaneous-switching noise. Therefore, it is desirable to weight particularly the number of flip-flops that are the fan-out of the clock gating cell among flip-flops triggered by the same clock to calculate the noise cost (NS).

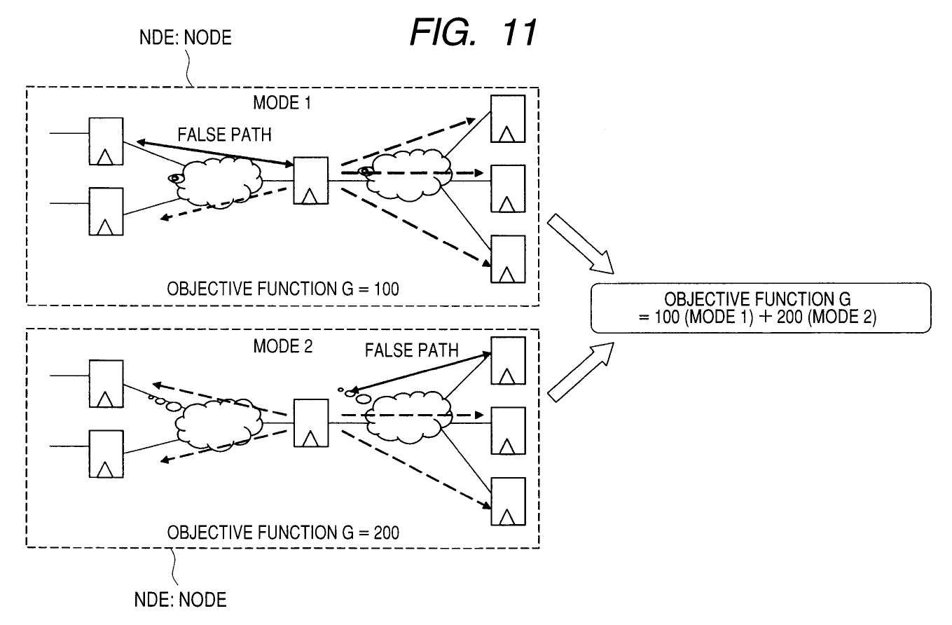

With [A] to [C], the objective function G expressed by equation (2) is calculated. Here, assume that a semiconductor device to be designed has, for example, a plurality of timing constraints. That is, for example, the semiconductor device to be designed has a mode in which it operates at a certain frequency and a mode in which it operates at another frequency. FIG. 11 is an explanatory diagram showing an example of a method for calculating the objective function in the case where the semiconductor device to be designed has a plurality of modes in the design method of FIG. 1.

As shown in FIG. 11, the semiconductor device has two modes (mode 1, mode 2), the locations of false paths in a node NDE differ between the modes, and the value of the objective function G for the node NDE is 100 in mode 1 and 200 in mode 2. In this case, the value of the objective function G for NDE is, for example, the sum of the values of the objective function in the two modes. Thus, by performing traces based on the sum of the values in the modes, it is possible to equalize the layout comprehensively in consideration of a plurality of modes and optimize the layout design. Further, the equivalent effect can be obtained by the use of the average or the like instead of the sum.

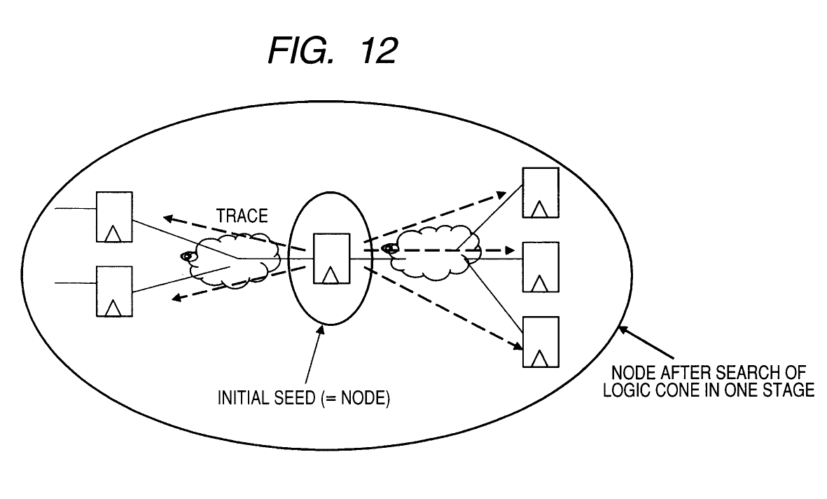

With the thus calculated objective function G, the computer system expands nodes in parallel so as to equalize the respective objective function G values of the nodes. FIG. 12 is an explanatory diagram showing an overview of a node expansion method in the trace (S103) in the design method of FIG. 1. As shown in FIG. 12, with each seed selected in S101 of FIG. 1 as an origin, the computer system traces the respective logic cone (i.e., takes in preceding or subsequent coupled flip-flops step by step), thus increasing logic contained in the node which is the effective range of each seed, in stages.

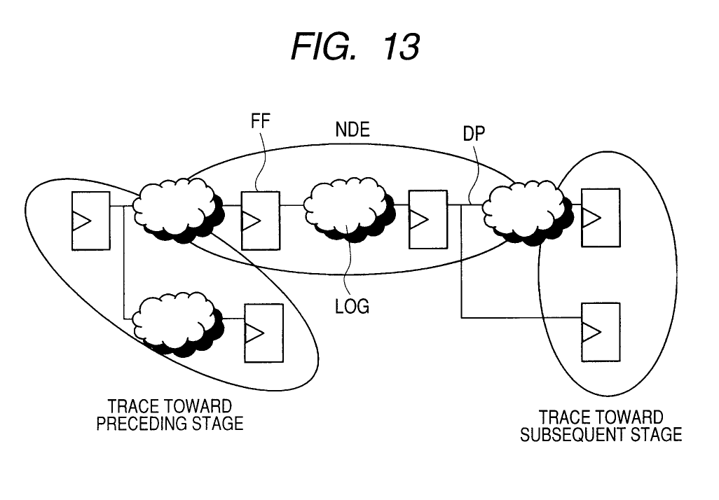

FIG. 13 is another explanatory diagram showing an overview of the node expansion method in the trace (S103) in the design method of FIG. 1. As shown in FIG. 13, only data buses DP are subject to the logic-cone trace, and reset lines, scan enable lines, and the like are not subject to the trace to avoid a possible case of a large fan-out. Further, there are two types of traces which are a forward trace toward FFs in the subsequent stage and a backward trace toward FFs in the preceding stage. As a result of tracing FFs in one stage from a node NDE, a plurality of FFs are picked up; however, only FFs not contained in the other nodes are incorporated into the node.

The trace shown in FIGS. 12 and 13 ends basically at the time of contact with another node. The end condition differs between a trace in the case of a flat hierarchy without a logical hierarchy and a trace in the case of maintaining the logical hierarchy. That is, in the trace, although it is desirable to determine division blocks from the flat hierarchy from the viewpoint of only layout quality, it may be desirable to determine division blocks while maintaining the logical hierarchy in consideration of readability etc. after layout. The design method according to this embodiment is applicable in either case, and the case of maintaining the logical hierarchy includes the following two cases.

The first case completely maintains the logical hierarchy. In this case, the flow of FIG. 1 is applied to layout data obtained by performing floorplan in accordance with the logical hierarchy, only for the purpose of shortening the layout processing time. This makes it possible to obtain data division units that enable shortening of the layout processing time. The second case optimizes the framework as appropriate while maintaining the logical hierarchy to the extent possible. In this case, the flow of FIG. 1 is applied at a stage prior to floorplan. Then, by performing floorplan based on the result, it is possible to improve the quality of the semiconductor device as well as to shorten the layout processing time. That is, in this case, in accordance with the flow of FIG. 1, an optimal bundle way is searched for in stages toward higher hierarchies with a lower hierarchy of the logical hierarchy as an origin. At this time, processing for maintaining the framework of the logical hierarchy to the extent possible and maintaining the uniformity of the division blocks is performed, so that the framework is maintained in lower hierarchies of the logical hierarchy and rearranged in higher hierarchies.

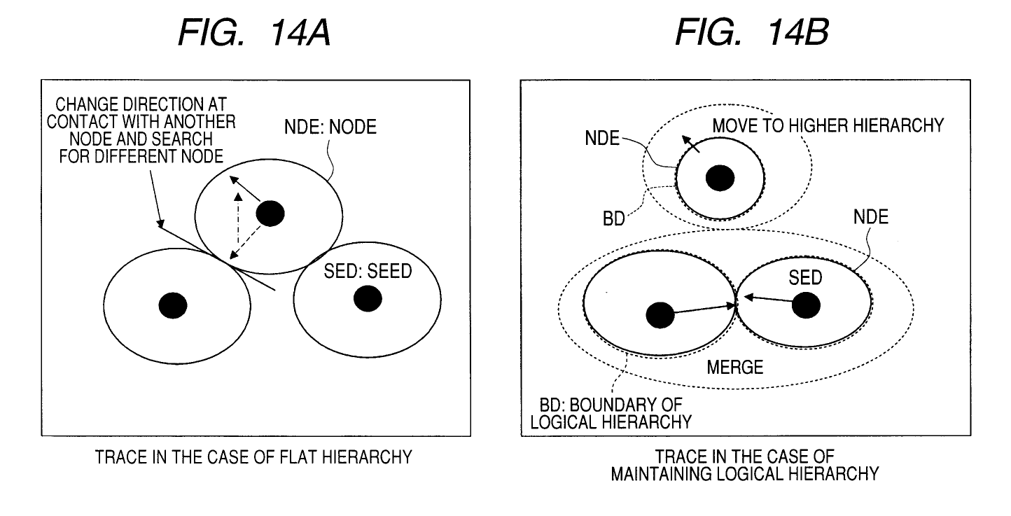

FIGS. 14A and 14B are conceptual diagrams showing an example of a processing method in the case where nodes come into contact with each other in the process of node expansion in FIGS. 12 and 13, in which FIG. 14A shows the case of a flat hierarchy, and FIG. 14B shows the case of maintaining a logical hierarchy. As shown in FIG. 14A, in the case of the flat hierarchy, when a node NDE comes into contact with another node, the search direction is changed and the trace is continued. Further, for example, when the node is surrounded by a plurality of adjacent nodes so that the trace cannot be performed in any direction, the node waits for a merge with any one of the adjacent nodes. On the other hand, as shown in FIG. 14B, in the case of maintaining the logical hierarchy, when a node NDE reaches the boundary BD of a logical hierarchy, it is determined whether to move to a higher hierarchy or wait for a merge with an adjacent node.

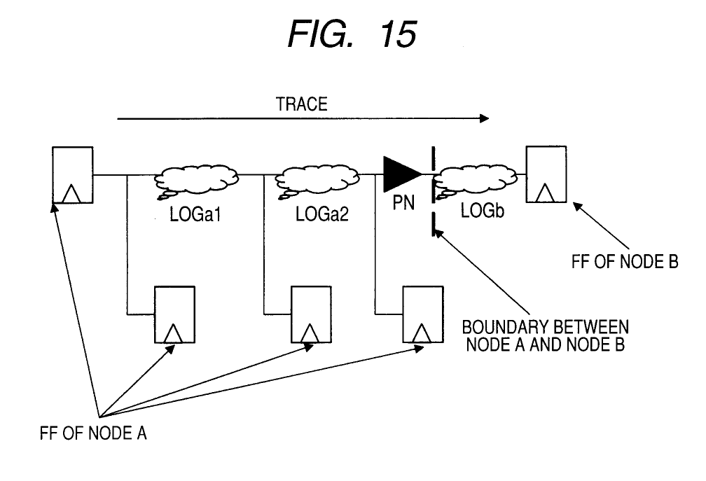

FIG. 15 is an explanatory diagram showing an example of how to determine a boundary in the case where nodes come into contact with each other in the process of node expansion in FIGS. 12 and 13. As shown in FIG. 15, for example, in a circuit in which the output of a flip-flop FF contained in a node B passes through a combinational circuit LOGb, branches at various points, and is inputted to each FF contained in a node A, when the nodes A and B come into contact with each other in the process of node expansion (trace), a boundary (boundary pin PN) is set between a branch point closest to the node B and the combinational circuit LOGb. Setting the boundary at such a location facilitates subsequent automatic layout.

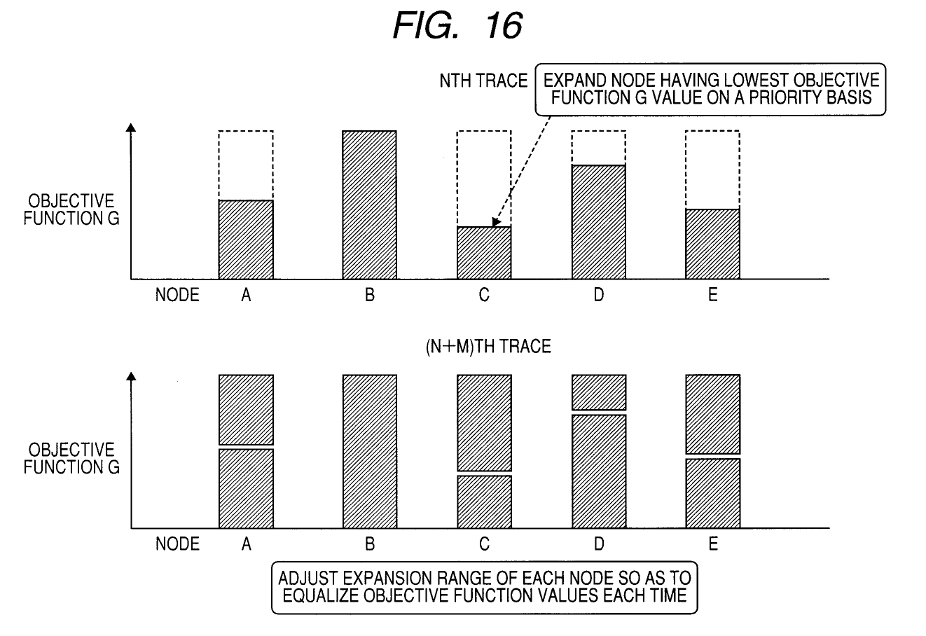

FIG. 16 is a conceptual diagram showing an example of changes in objective functions in the process of the trace (S103) in the design method of FIG. 1. As shown in FIG. 16, first, each node A to E is expanded in parallel in a certain range, and then the respective objective function G values of the nodes are calculated. Then, a node (node C in FIG. 16) having the lowest objective function value is expanded in a certain range, and then the value of the objective function for the node C is calculated. If the value of the objective function for the node C is thereby not the lowest in the nodes A to E, a node having the lowest objective function value is expanded in the same way, and then the value of the objective function is calculated. If the node C has the lowest value, the node C is expanded again, and then the value of the objective function is calculated. Consequently, it becomes possible to expand nodes as appropriate while equalizing the respective objective function values of the nodes.

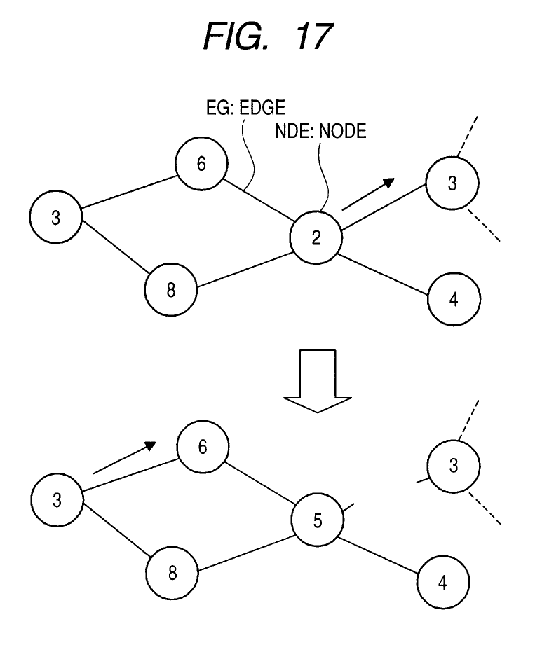

FIG. 17 is a conceptual diagram showing an example of a trace graph generated in the trace (S103) in the design method of FIG. 1. In the trace (S103) in FIG. 1, the computer system performs a trace while sequentially generating such a trace graph as in FIG. 17. In the trace graph shown in FIG. 17, each node NDE is represented by a circle, whether there is coupling through a combinational circuit and a flip-flop between nodes is represented by an edge EG, and the value of the objective function for each node is represented by a numeral in each node. The trace direction of each node is determined based on the trace graph, for example, determined in a direction toward a node having a low (or high) objective function value.

For example, FIG. 17 shows an example of a trace in a direction toward a node having a low objective function G value. First, a node of “2” of the lowest G value is traced in a direction toward a node of “3” of the lowest G value in the neighboring nodes. Then, in the process of the trace, when the node of “2” comes into contact with the node of “3”, the edge between the two nodes vanishes, and the trace in the direction toward the node of “3” is not performed thereafter. Then, in a state of the vanishment of the edge, the G value of the node of “2” is calculated and assumed to be e.g. “5”. In this case, in the next stage, a node of “3” of the currently lowest objective function G value is traced in a direction toward a node of “6” of the lowest G value in the neighboring nodes.

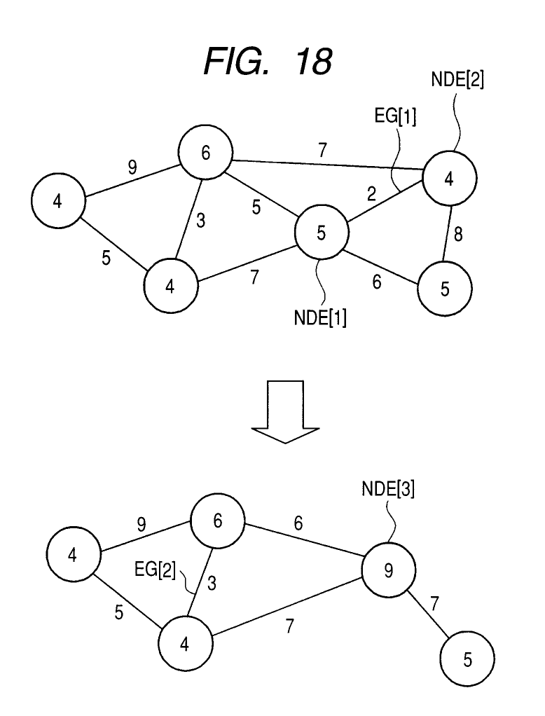

FIG. 18 is a conceptual diagram showing an example of a merge graph generated in the merge (S104) in the design method of FIG. 1. In the merge (S104) in FIG. 1, the computer system performs a merge while sequentially generating such a merge graph as in FIG. 18. In the merge graph shown in FIG. 18, each node NDE located adjacently in the process of the trace is represented by a circle, and an edge EG is coupled between adjacent nodes. Further, the value of the objective function for each node is represented by a numeral in each node, and the degree of correlation (edge cost) in coupling between nodes is represented by a numeral on the edge EG. The edge cost decreases in number as the degree of logical coupling between the corresponding nodes (i.e., the number of logical connections between the nodes obtained from the netlist NL) increases. Further, if floorplan information FP exists, the edge cost decreases in number as the physical distance between the corresponding nodes decreases.

A merge is performed preferentially on a location where the edge cost is low in number (i.e., the correlation between the corresponding nodes is high). In the example of FIG. 18, an edge EG[1] having the lowest value “2” preferentially undergoes a merge, so that a node NDE[1] whose objective function G value is “5” and a node NDE[2] whose objective function G value is “4” are merged into one node NDE[3]. As a result, the G value of the node NDE[3] becomes, e.g., “9”. In this case, the G value of NDE[3] becomes temporarily higher than those of the other nodes. However, other nodes subsequently undergo a merge (e.g., an edge EG[2] undergoes a merge), so that the respective objective function G values of the nodes are equalized in stages. If the node NDE[3] instead of another node becomes a further merge target, it may become difficult to equalize the objective functions G. Therefore, if a merge is likely to cause a big gap between the node and another node (e.g., the maximum value becomes more than three times the minimum value), it is desirable to place such a restriction that the merge is not performed.

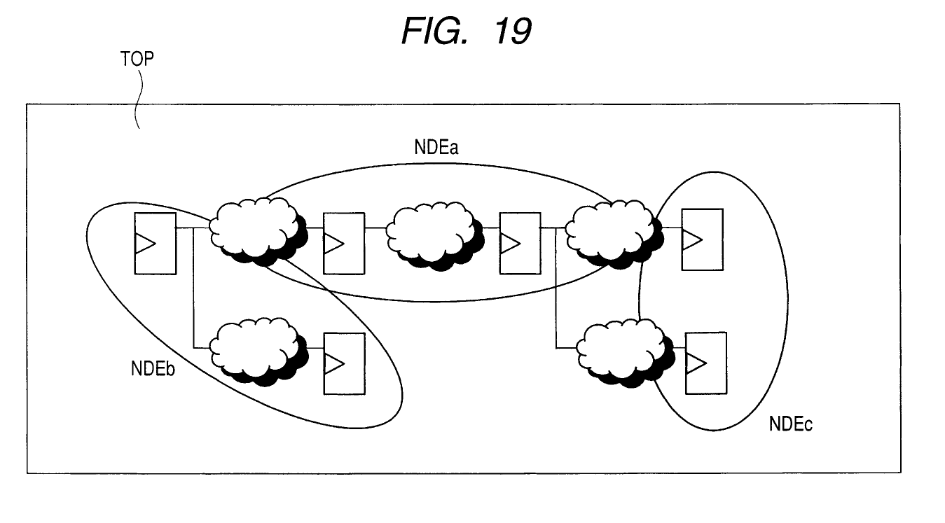

FIG. 19 is an explanatory diagram of the total cost calculation (S107) in the design method of FIG. 1. In FIG. 19, the entire semiconductor device is comprised of, for example, three nodes NDEa, NDEb, and NDEc, and the highest hierarchy TOP which is the other circuits. In the total cost calculation (S107) in FIG. 1, as expressed in equation (1), the total cost is calculated by summing the maximum value or the like of the respective objective functions for the nodes and the top cost. The top cost is calculated, for example, based on the number of timing paths etc. of the circuits contained in the highest hierarchy TOP. The top cost decreases as each node expands. Further, for example, if the nodes NDEa and NDEb are merged, the value of the objective function for the node after the merge increases, whereas the top cost remains the same or decreases.

Thus, with the semiconductor device design method according to the first embodiment, it is possible to obtain a plurality of division blocks equalized comprehensively including processing time and quality and to search for an optimal solution to the range of each division block and the number of division blocks. Therefore, by laying out each division block in parallel processing based on this result, it is possible to shorten the layout processing time. Further, by performing floorplan or allocation to a plurality of semiconductor chips based on this result, it is possible to perform optimization including the quality of the semiconductor device and the layout processing time. Thus, it is possible to optimize the layout design from the comprehensive viewpoint.

### Second Embodiment

In the second embodiment, description will be made as to the application of the design method according to the first embodiment to parallel automatic layout using a plurality of computer systems having different processing capabilities. In the first embodiment, division is performed so as to equalize the respective objective function values (including layout processing time) of the nodes. However, in the case where distributed processing hardware devices have different specs, the processing time may be shortened if the respective objective function values of the nodes have a predetermined ratio according to the different specs. Accordingly, in a semiconductor device design method according to the second embodiment, appropriate division is performed in consideration of the specs (CPU, memory) of distributed processing hardware devices, and each processing is assigned to the respective hardware device.

For example, the hardware specs of the computer systems for performing automatic layout are as follows.

CPU1: cpuf=100 MHz Memory=4 GB CPU2: cpuf=200 MHz Memory=8 GB CPU3: cpuf=300 MHz Memory=16 GB CPU4: cpuf=400 MHz Memory=32 GB
In this case, in terms of the CPU specs, the ratio among the processing capabilities of the CPUs is, for example, as follows. CPU1:CPU2:CPU3:CPU4=1:2:3:4
In this case, for example, CPU4 has processing capability four times as high as that of CPU1 and can therefore process a node having an objective function value four times as high as that of CPU1 within the same layout processing time. Accordingly, in a first method for semiconductor device design according to the second embodiment, in the trace (S103) and the merge (S104) in the flow of FIG. 1 described in the first embodiment, the systems increase the respective objective function values of the nodes while maintaining the ratio of 1:2:3:4 with four nodes as a unit. For example, in the case of eight nodes, the ratio among the respective objective function values of the nodes is 1:2:3:4:1:2:3:4 or the like.

Alternatively, in a second method, the systems may perform control so as to equalize the respective objective function values of the nodes in the same way as in the first embodiment and change the number of nodes finally assigned to each CPU. For example, in the case of ten nodes obtained as the final solution, one, two, three, and four nodes are assigned to CPU1, CPU2, CPU3, and CPU4, respectively. Further, there is no problem if resources are determined; however, in such a case of sharing resources through management software such as LSF (Load Sharing Facility), usable resources change dynamically; therefore, it is dealt with by spec equalization or specified block number.

Thus, with the semiconductor device design method according to the second embodiment, in addition to the various effects described in the first embodiment, it is possible to shorten the layout processing time even if a plurality of computer systems having different hardware specs perform automatic layout.

### Third Embodiment

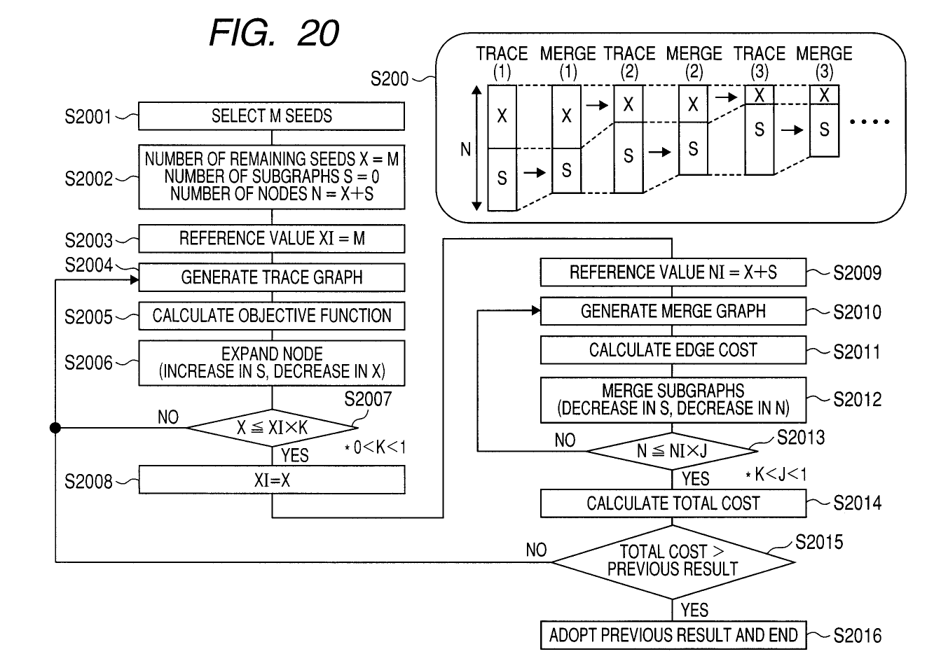

In the third embodiment, the design method of FIG. 1 according to the first embodiment will be described in greater detail. FIG. 20 is a flowchart showing an example of processing in a semiconductor device design method according to the third embodiment of the invention. In FIG. 20, first, the computer system selects M seeds in the same way as in S101 of FIG. 1 (S2001), and substitutes M for the number of remaining seeds (the number of not-yet-subgraphed seeds) X, 0 for the number of subgraphs S, and X+S for the number of nodes N as initial conditions (S2002). Then, after setting a reference value XI=M (S2003), the computer system performs a trace.

In the trace, the computer system repeats the loop processing of trace graph generation (S2004), objective-function calculation (S2005), and node expansion (S2006) until the number of remaining seeds X≦XI×K (S2007). K is an arbitrary value between 0 and 1 (0<K<1). That is, the computer system converts a node that meets a predetermined condition into a subgraph and continues to expand nodes until the number of remaining seeds which have not yet been converted into a subgraph decreases to a predetermined rate while expanding nodes so as to equalize the respective objective function values of the nodes in the same way as in the first embodiment. That is, as the trace proceeds, the number of subgraphs S increases, and the number of remaining seeds X decreases accordingly. The subgraph refers to a node that reaches the following state. All perimeters of the node come into contact with other nodes etc. in the process of node expansion and cannot expand any further. If the number of remaining seeds decreases to the predetermined rate, the computer system exits the loop and updates the reference value XI with the number of currently remaining seeds X (S2008).

Then, after setting a reference value NI=X+S (S2009), the computer system performs a merge. In the merge, the computer system repeats the loop processing of merge graph generation (S2010), edge cost calculation (S2011), and subgraph merge (S2012) until the number of nodes N≦NI×J (S2013). J is an arbitrary value between K and 1 (K<J<1). That is, the computer system merges adjacent subgraphs of a plurality of subgraphs generated by the trace. With the merge, the number of subgraphs decreases, and the number of nodes N (the sum of the number of subgraphs S and the number of remaining seeds X) also decreases accordingly. If the number of nodes N decreases to a predetermined rate, the computer system exits the loop.

After exiting the loop, the computer system calculates a total cost using equation (1) as in the first embodiment (S2014). If the total cost is higher than the previously calculated total cost (i.e., the total cost has worsened), the previously calculated total cost is an optimal solution, the previous number of nodes N is an optimal division number, and the boundary of each node is an optimal division boundary (S2016). On the other hand, if the total cost is lower than the previously calculated total cost (i.e., the total cost has improved), the computer system returns to S2004 and performs a trace again. In the trace, with the number of currently remaining seeds X as the reference value XI, conversion into the subgraph is performed in the remaining seeds, and the trace is continued until the number of remaining seeds decreases to the predetermined rate. Subsequently, in the same way, with the current number of nodes as the reference value NI, subgraphs are merged until the number of nodes decreases to the predetermined rate. Accordingly, as shown in S200 in FIG. 20, the processing proceeds while decreasing the number of remaining seeds X and the number of nodes N in stages.

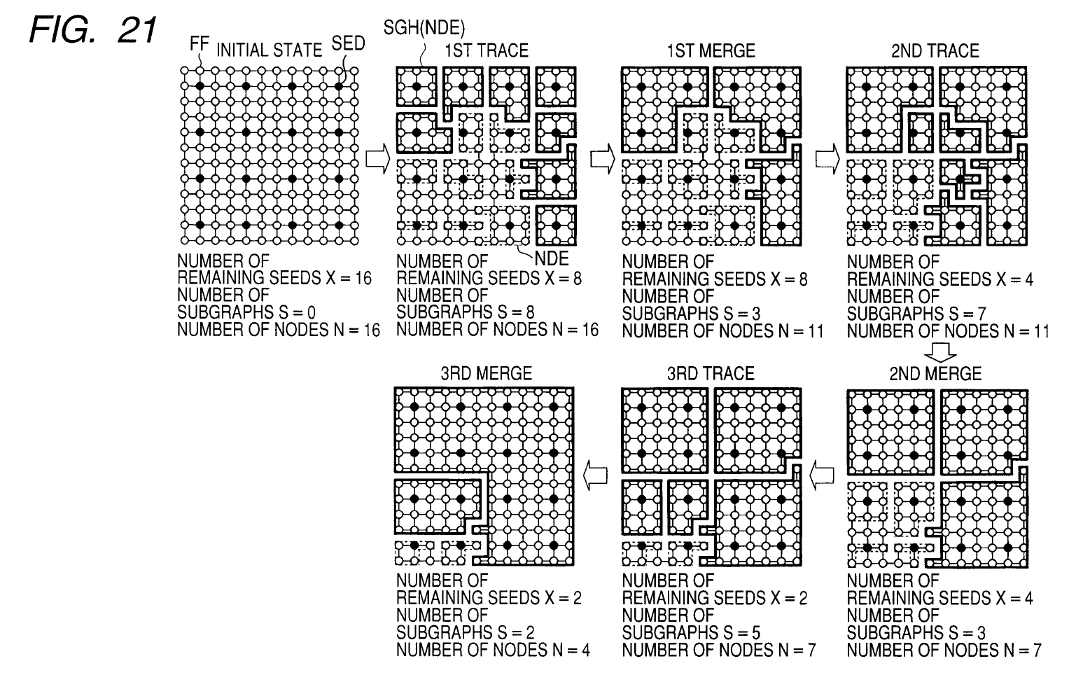

FIG. 21 is a schematic diagram showing an example of transition of processing objects, in accordance with the flow of FIG. 20. In FIG. 21, the K and J values are, e.g., 0.5 and 0.7 respectively, and 16 seeds are selected as an initial state and processed. FIG. 21 schematically shows circuits comprised of a plurality of flip-flops FF coupled as appropriate through combinational circuits (not shown), and in the initial state, 16 seeds SED are selected uniformly from the flip-flops FF. Subsequently, in the first trace, each node NDE with each seed as an origin expands in stages, and a node that has reached the limit of expansion becomes a subgraph SGH. As described in the first embodiment, the expansion speed of each node NDE varies according to the comprehensive complexity of circuits contained in each node. The first trace is continued until the number of remaining seeds X decreases from 16 (before the trace) to 8 (about 0.5 times 16), and eight subgraphs SGH are generated accordingly.

Then, the first merge is performed on the subgraphs SGH until the number of nodes N decreases from 16 (before the merge) to 11 (about 0.7 times 16). The number of nodes N is the sum of the number of remaining seeds X and the number of subgraphs S, and the number of remaining seeds X cannot be changed; therefore, the merge is performed until the number of subgraphs S decreases from 8 to 3. Subsequently, in the same way, the second trace is performed until the number of remaining seeds X decreases to 4 (about 0.5 times the number before the trace), and the second merge is performed until the number of nodes N decreases to 7 (about 0.7 times the number before the merge). The subsequent traces and merges are performed in the same way.

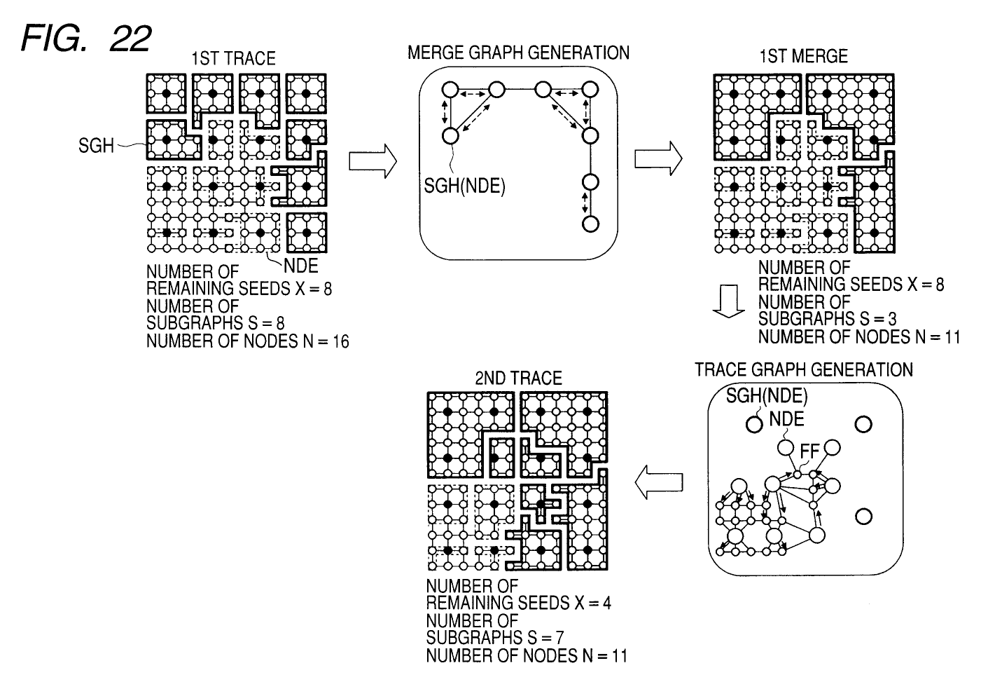

FIG. 22 is an explanatory diagram showing an example of a merge graph generated after the first trace in FIG. 21 and a trace graph generated after the first merge, in accordance with the transition of FIG. 21. In the merge graph, as illustrated in FIG. 18, nodes (subgraphs SGH in FIG. 22) to be merged are represented by circles, and the coupling relationship between nodes is represented by an edge. Although not shown in FIG. 22, each node has the value of the objective function, and each edge has an edge cost. In the merge graph generation, merges indicated by bidirectional arrows are performed respectively based on edge costs, thus bringing about the state of the first merge shown in FIG. 22.

On the other hand, in the trace graph, as illustrated in FIG. 17, nodes NDE to be traced are represented by circles, and whether there is coupling between nodes is represented by an edge. Although not shown in FIG. 22, each node has the value of the objective function. Further, as illustrated in FIG. 17, the edge is cut when nodes come into contact with each other; therefore, the subgraph SGH which is a kind of node NDE does not have the edge. In the trace graph generation, traces are performed respectively in directions indicated by arrows based on the values of the objective functions for nodes, thus bringing about the state of the second trace shown in FIG. 22.

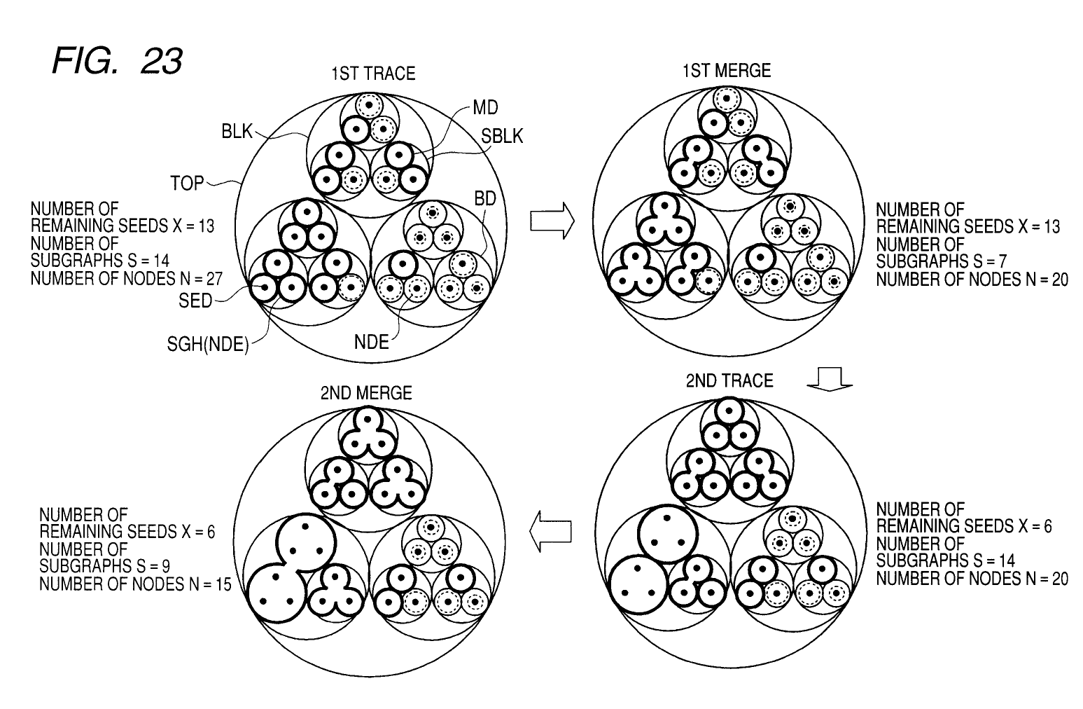

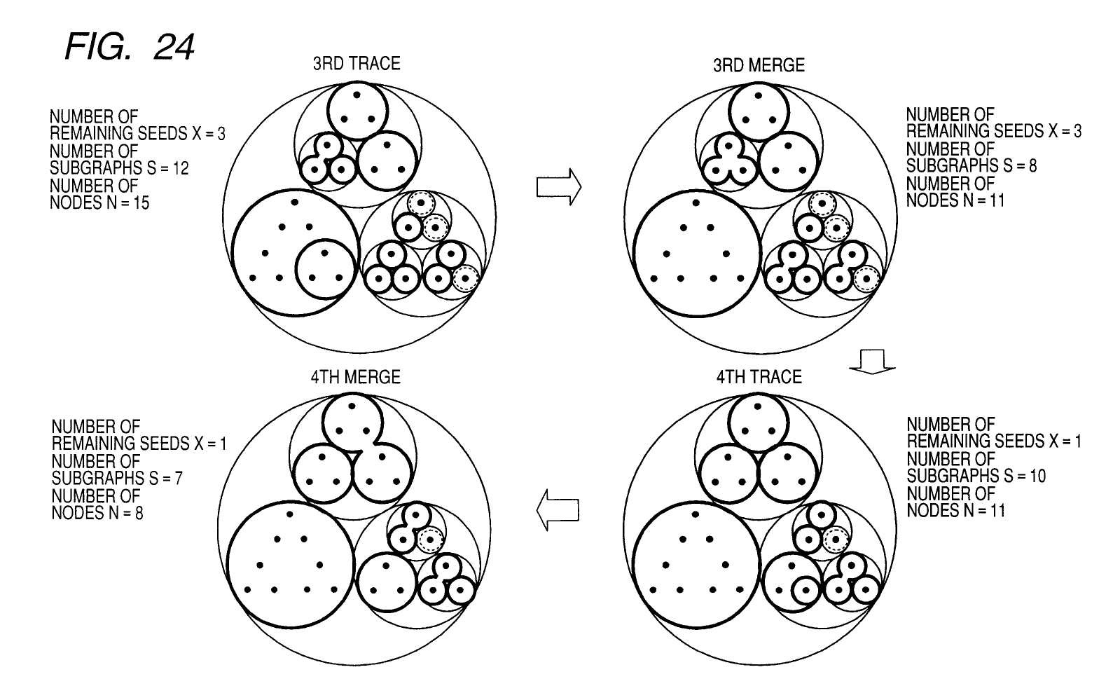

FIG. 23 is a schematic diagram showing another example of transition of processing objects, in accordance with the flow of FIG. 20, and FIG. 24 is a schematic diagram following FIG. 23. While FIG. 21 shows an example of transition of processing objects in the case of a flat hierarchy, FIGS. 23 and 24 show an example of transition of processing objects in the case of maintaining a logical hierarchy. In FIGS. 23 and 24, the K and J values are, e.g., 0.5 and 0.75 respectively, and 27 seeds are selected as an initial state and processed. In the logical hierarchy, for example, the highest hierarchy TOP has three blocks BLK, each block BLK has three subblocks SBLK, each subblock SBLK has three modules MD, and one seed SED is selected from each module MD.

Subsequently, in the first trace, each node NDE with each seed as an origin expands in stages, and a node that has reached the limit of expansion becomes a subgraph SGH. In the case of maintaining the logical hierarchy, unlike the flat hierarchy shown in FIG. 21, when the perimeter of each node reaches the boundary BD of each logical hierarchy (block BLK, subblock SBLK, module MD), the node reaches the limit of expansion. As described in the first embodiment, the expansion speed of each node NDE varies according to the comprehensive complexity of circuits contained in each node. The first trace is continued until the number of remaining seeds X decreases from 27 (before the trace) to 13 (about 0.5 times 27), and 14 subgraphs SGH are generated accordingly.

Then, the first merge is performed on the subgraphs SGH until the number of nodes N decreases from 27 (before the merge) to 20 (about 0.75 times 27). The number of nodes N is the sum of the number of remaining seeds X and the number of subgraphs S, and the number of remaining seeds X cannot be changed; therefore, the merge is performed until the number of subgraphs S decreases from 14 to 7. In this example, e.g., three subgraphs SGH (modules MD) are merged into one subgraph SGH, and two subgraphs SGH (modules MD) are merged into one subgraph SGH.

Subsequently, the second trace is performed until the number of remaining seeds X decreases to 6 (about 0.5 times the number before the trace). At this time, for example, the subgraph SGH generated by merging the three modules MD is moved to a higher hierarchy and traced. Then, the second merge is performed until the number of nodes decreases to 15 (about 0.75 times the number before the merge). In this example, in addition to merges in the module hierarchy as in the first merge, merges in the subblock hierarchy are performed, for example, two subgraphs SGH (subblocks SBLK) are merged into one subgraph SGH. Subsequently, in the same way, as shown in FIG. 24, the third trace and merge, the fourth trace and merge, . . . are performed sequentially. Accordingly, the number of nodes N decreases in stages, and merges in a higher hierarchy proceed.

Thus, either in the case of the flat hierarchy or maintaining the logical hierarchy, the total cost is calculated each time while the number of nodes N is decreased. In the end, the number of nodes N of the best total cost is an optimal division number, and the boundary of each node is an optimal division boundary. Therefore, by performing automatic layout in parallel processing based on this division unit, it is possible to shorten the layout processing time. Further, by performing floorplan, allocation to the chips, or the like based on this division unit, it is possible to optimize the layout design comprehensively including the layout processing time and the quality of the semiconductor device.

While the invention made above by the present inventors has been described specifically based on the illustrated embodiments, the present invention is not limited thereto, and various changes and modifications can be made thereto without departing from the spirit and scope of the invention.

The semiconductor device design method according to the above embodiments is a technique effective in application to a layout design method for a semiconductor device, such as a microcomputer, containing mixed circuit blocks having different functions, but is not limited thereto and can widely be used as a layout design method for various semiconductor devices.

What is claimed is:

1. A semiconductor device design method allowing a computer system to execute, in layout design of a semiconductor device including a plurality of flip-flop circuits and combinational circuits coupled as appropriate among the flip-flop circuits:
a first step of allocating the flip-flop circuits and the combinational circuits to N blocks so as to equalize respective objective function values of the blocks, with a predetermined reference value as a target, by referring to a netlist of the semiconductor device,
wherein an objective function for each block includes a first variable reflecting timing information of a circuit contained in a respective block.

2. The semiconductor device design method according to claim 1, wherein the timing information contains clock frequency information for the flip-flop circuits.

3. The semiconductor device design method according to claim 1, wherein the timing information contains information about a result of performing static timing analysis on a timing path through the combinational circuits among the flip-flop circuits.

4. The semiconductor device design method according to claim 1, wherein the objective function for each block further includes a second variable reflecting the number of flip-flop circuits triggered by a same clock and contained in the respective block.

5. The semiconductor device design method according to claim 4, wherein the objective function for each block further includes a third variable reflecting the magnitude of power consumption of each cell in the circuit contained in the respective block.

6. The semiconductor device design method according to claim 1, wherein the computer system further executes a second step of performing floorplan, with the N blocks generated in the first step as a unit.

7. The semiconductor device design method according to claim 1, wherein the computer system further executes a third step of performing automatic layout processing in parallel using a plurality of CPUs, with the N blocks generated in the first step as a parallel processing unit.

8. A semiconductor device design method allowing a computer system to execute, in layout design of a semiconductor device including a plurality of flip-flop circuits and combinational circuits coupled as appropriate among the flip-flop circuits:
a first step of selecting M flip-flop circuits from among the flip-flop circuits by referring to a netlist of the semiconductor device and setting the M flip-flop circuits as seeds;
a second step of expanding each seed in parallel so as to equalize respective objective function values while taking in, step by step, a flip-flop circuit located in a preceding or subsequent stage for each of the M seeds as an origin, converting a seed that satisfies a first condition in the process of expansion into a subgraph, and continuing to expand each seed until the number of remaining seeds which have not yet become a subgraph decreases to a first rate;
a third step of merging subgraphs until the sum of the number of remaining seeds and the number of subgraphs decreases to a second rate;
a fourth step of calculating a total cost based on the respective objective function values of the remaining seeds and the subgraphs and the number of timing paths of a circuit that does not belong to the remaining seeds or the subgraphs; and
a fifth step of repeating the second to fourth steps until the total cost worsens,
wherein each objective function includes a first variable reflecting timing information of a circuit contained in the expansion range of each seed.

9. The semiconductor device design method according to claim 8,
wherein the second step is performed in a state where a logical hierarchy of the netlist is flat, and
wherein the first condition holds in the case where the seed cannot expand any further due to contact with the expansion range of another seed.

10. The semiconductor device design method according to claim 8,
wherein the second step is performed in a state where a logical hierarchy of the netlist is maintained, and
wherein the first condition holds in the case where the seed cannot expand any further due to contact with the boundary of a logical hierarchy.

11. The semiconductor device design method according to claim 8, wherein the timing information contains clock frequency information for the flip-flop circuits.

12. The semiconductor device design method according to claim 8, wherein the timing information contains information about a result of performing static timing analysis on a timing path through the combinational circuits among the flip-flop circuits.

13. The semiconductor device design method according to claim 8, wherein the objective function further includes a second variable reflecting the number of flip-flop circuits triggered by a same clock and contained in the expansion range of each seed.

14. The semiconductor device design method according to claim 13, wherein the objective function further includes a third variable reflecting the magnitude of power consumption of each cell in the circuit contained in the expansion range of each seed.

15. The semiconductor device design method according to claim 8, wherein in the first step, the computer system searches a logical hierarchy of the netlist toward a lower layer, detects lower layer blocks that are about the same in number as the M seeds, and sets a seed from each of the detected lower layer blocks.

16. The semiconductor device design method according to claim 15, wherein at the time of setting the seed from each of the detected lower layer blocks, the computer system detects, from each of the detected lower layer blocks, flip-flop circuits for input or output with the outside of the lower layer block, and sets a flip-flop circuit coupled through the largest number of stages from the flip-flop circuits as the seed.

17. The semiconductor device design method according to claim 8, wherein the computer system further executes a sixth step of recognizing the remaining seeds and the subgraphs of the best total cost, using a result of the fifth step and performing floorplan, with each of the remaining seeds and the subgraphs of the best total cost as a block unit.

18. The semiconductor device design method according to claim 8, wherein the computer system further executes a seventh step of recognizing the remaining seeds and the subgraphs of the best total cost, using a result of the fifth step and performing automatic layout processing in parallel using a plurality of CPUs, with each of the remaining seeds and the subgraphs of the best total cost as a parallel processing unit.
